(19) United States
(12) Patent Application Publication
(10) Pub. No.: US 2018/0353274 A1
(43) Pub. Date: Dec. 13, 2018

(54) ADJUSTABLE INTERDENTAL CLEANING ELEMENT AND A DEVICE AND METHOD THEREFOR

(71) Applicant: Amir Horowitz, Kiryat Ono (IL)

(72) Inventor: Amir Horowitz, Kiryat Ono (IL)

(21) Appl. No.: 16/052,949

(22) Filed: Aug. 2, 2018

Related U.S. Application Data
(63) Continuation-in-part of application No. PCT/IL2017/050116, filed on Feb. 1, 2017.

(30) Foreign Application Priority Data
Feb. 2, 2016 (IL) 243912

(51) Int. Cl. A61C 15/04; A61C 19/06

(52) U.S. Cl. CPC A61C 15/046; A61C 19/063

(57) ABSTRACT

A dental hygiene device which comprises first and second spaced fixed elements, a third element interconnected with both said first and second elements to define an opening between said first and second elements within which a dental structure to be flossed is receivable, an elongated cleaning element usable in a flossing operation with first and second longitudinal ends, a first member by which said cleaning element is held and selectively directable from said first element to said second element, and a second member associated with said second element by which said cleaning element is detachably secured. The dental hygiene device is preferably operated by one hand only. In addition, the user can clean the entire mouth using one dental hygiene device.

### REFERENCE TO RELATED APPLICATIONS

This is a continuation-in-part application of International Patent Application No. PCT/IL2017/050116 filed Feb. 1, 2017, which claims priority from Israeli Patent Application No. 243912 filed Feb. 2, 2016.

### FIELD OF THE INVENTION

The present invention relates to the field of dental hygiene devices. More particularly, the invention relates to a device comprising an adjustable and elongated interdental cleaning element.

### BACKGROUND OF THE INVENTION

It is obligatory to use dental floss in order to remove food particles and plaque from interdental teeth surfaces, below and above the gingival line, to enhance dental hygiene. This should be done in addition to the use of a toothbrush that removes plaque that has accumulated on the buccal and lingual teeth surfaces.

A usual cause of periodontitis is dental plaque which accumulates subgingivally in the sulcus. As shown in FIG. 6, the gingival sulcus 52 is a “space” which is located between the crown 54 of a tooth and the sulcular epithelium 57, at the edge of the gingiva 51. The sulcus 52 is coronally bounded by the free gingival margin 58 at the most coronal portion of the gingiva 51 and is apically bounded by gingival fibers at the epithelial attachment 59, and in healthy gums has a depth of approximately 1 mm.

Dental floss is well suited to be introduced into the gingival sulcus. If dental floss is not used, food particles and germs tend to accumulate within the sulcus and on the interdental teeth surfaces, eventually converted to plaque 61, which is a bacterial biofilm adhering on tooth surfaces, as shown in FIG. 7. The plaque, if not removed by means of a toothbrush and dental floss, leads to the buildup of hardened calculus, which can be removed only with use of dedicated dental tools (e.g., ultrasonic scalier, curettes, sometimes surgery is needed, as well).

The accumulation of calculus in the subgingival regions causes receding bone and gums, from a healthy bone level 64 to a reduced bone level 66. The receding bone results in deepening the gingival sulcus to create periodontal pockets, rendering the cleaning of the subgingival regions very difficult without professional help. This destructive process might lead to tooth mobility and at the end tooth loss.

Many kinds of flossing devices are known from the prior art, including regular dental floss, Superfloss™, and those that have two arms across which a strand of floss is irremovably pre-strung. These dental floss and holders have great utility in helping to remove food debris that has accumulated within the gingival sulcus and along the interdental teeth surfaces.

Vertical movement, coronally and apically, is transmitted to the floss to scrape the accumulated food particles and plaque from the teeth surfaces (from the very bottom of the sulcus to the contact point that must exist between teeth).

No other known hygiene element can reach and clean these areas.

However, many times teeth are interconnected for the use of splinted or ligatured teeth, and floss is accordingly unable to access the gingival sulcus and the interdental spaces, from the occlusal direction, due to the presence of the interconnecting elements that extend mesiodistally or interproximally between teeth. Interconnecting elements can exist due to orthodontic, periodontic, prosthodontic or surgical reasons, and regular dental floss cannot be used through the occlusal direction.

An exception must be emphasized regarding Superfloss™ and the different kinds of threading/stringing elements that exist in the market. These elements are able to be thread through the interproximal gaps from the buccal to the lingual sides in a fashion that resembles sewing. This is in contrary to conventional floss which penetrates the interdental space through the occlusal part of the teeth. As will be discussed later, this is a very difficult maneuver, much more than using conventional floss that unfortunately, only relatively low percentage of the world population are using it.

The following are different dental treatments and conditions for which dental floss is unable to clean the gingival sulcus and the interdental spaces:
1. Orthodontic treatment: Braces and ligatures which are installed during orthodontic treatment and interfere with the passage of the floss from the occlusal direction towards the interdental space and sulcus.
2. Post-orthodontic therapy: A splint is joined to realigned teeth immediately after orthodontic therapy in order to prevent relapse (since teeth have memory and will return to their original position unless splinted).
3. Prosthodontic treatment: The use of a bridge framework in case of missing teeth. Bridge frameworks are common in the prosthodontic field of dentistry when teeth are missing and the space is not completed by means of implants.
4. Implantology: In many cases where dental implants are used there is still a need to interconnect between the implants in the phase of the rehabilitation-prosthodontics. For example, adjacent implants located in poor quality bone (D4 tuberosity) where better load distribution is needed. An implant is not always used for every tooth. Many times, two implants will support 3, 4, or 5 teeth, sometimes even more.
5. Periodontal treatment: Teeth which already suffer due to loss of surrounding bone to support and present an increasing mobility must as well be interconnected, i.e. splinted, in order to reduce masticatory and occlusal forces.
6. Surgical treatment: Wires are passed interproximally between teeth that are located close to a fracture line during maxillofacial surgery, for stabilizing the fracture.

Cleaning teeth properly is hard enough, cleaning interconnected teeth with different kinds of splints and legatures is much harder.

In all the aforementioned cases it is impossible to maintain high quality hygiene unless floss is used properly to clean the interdental surfaces of the teeth from the very bottom of the sulcus and as close as possible to the contact point and the interconnecting element.

As mentioned there some devices as Superfloss™ and threaders in the market but none of them is user friendly if not impossible to use.

The mouth is relatively small compared to two big hands that must manipulate floss inside it. Even for young adults, not to mention elderly people, flossing is not easy.

Therefore, it would be desirable (and even essential) to provide a dental hygiene flossing device that can be easily used both when teeth are interconnected and also for healthy dentition when all teeth are separated and not interconnected.

U.S. Pat. No. 4,008,727 discloses an interproximal space tooth cleaner formed by a plurality of elongate filaments to have a variable diameter brush portion of spongy elastic material and a string portion, with the string portion having two parts and with the brush portion being located between the two parts. The user may, by the use of either string portion, pull the cleaner through a space associated for example with braces or bridges in either direction, and if a snag develops, simply reverse the direction of movement by pulling on the other string part. The string parts may be flexible, or for spaces associated with fixed bridges may be formed with a rigid end extent for enabling insertion by pushing into the spaces.

The manipulation of this tooth cleaner requires considerable dexterity and also the use of two hands. A user of limited dexterity or one who has a hand disability would not be able to benefit from the use of the cleaner.

U.S. Pat. No. 5,829,458 discloses a dental flossing device comprising a body part having spaced-apart arms, a strand of dental floss extending between the arms and attached thereto, and a handle extending away the body part. A pick having a stem with sides and a tip end is die-cut generally centrally of the handle. The handle further defines a marginal strip situated adjacent and outward of the sides and terminal end of the pick, such that the marginal strip is bendable with respect to the stem, so as to be separable from the stem and leaving the pick exposed for use.

WO 2012/116451 discloses a floss pick including a body with a handle and a head. The body or handle defines an aperture in which a toothpick member is disposed. The toothpick member is connected to the handle by two bridge members, which may be broken in a first embodiment to detach the toothpick member or may be twisted in a second embodiment to pivot the toothpick member to a position where it is disposed at an angle relative to the body. The toothpick member is pivoted by engaging a terminal end thereof with an index finger, and the angle of the toothpick member relative to the body is adjusted using the index finger to permit picking of the teeth without changing hands.

The toothpick members of these two previously mentioned prior art floss holders are excessively thick, being capable of removing food debris that is lodged in large interdental spaces located coronally with respect to the gingival margin but not food particles in small interdental spaces that are normally removed non-professionally only by dental floss if not restricted by the presence of the interconnecting elements. It is needless to say that these prior art toothpick members are incapable of removing food debris that has accumulated within the sulcus located apically with respect to the gingival margin, often at a depth of only 3 mm. An additional drawback of these prior art floss holders is that the holder has to be repositioned within the hand of the user in order to change its usage from flossing to picking teeth, or vice versa, causing a considerable increase in the time needed to perform a food particle removal operation.

It is an object of the present invention to provide a dental hygiene device that facilitates accessing the gingival sulcus and interdental surfaces from the buccal direction to help in removing food debris that has accumulated thereat despite the presence of interconnecting elements that extend mesiodistally or interproximally between teeth.

It is an additional object of the present invention to provide a dental hygiene device for the entire mouth that allows consecutive teeth to be flossed, without removing the device from the oral cavity.

It is an additional object of the present invention to provide a multi-purpose interdental cleaning element that is sufficiently thin to facilitate removal of food debris that has accumulated within the gingival sulcus.

It is yet an additional object of the present invention to provide a multi-purpose interdental cleaning element that can function both as dental floss and as a toothpick.

It is yet an additional object of the present invention to provide a dental hygiene device for one-handed use that supports a change in usage from flossing to picking teeth, or vice versa, without having to be repositioned within the hand of a user.

It is yet an additional object of the present invention to provide a multi-purpose interdental cleaning element that can function as a dental floss, while optionally conveying therapeutic substances, sprinkled on the cleaning element.

Other objects and advantages of the invention will become apparent as the description proceeds.

### SUMMARY OF THE INVENTION

Prior art floss holders are incapable of facilitating removal of food debris that has accumulated within the sulcus located apically with respect to the gingival margin when interconnecting elements that extend mesiodistally or interproximally between teeth are present since the apically displaced floss cannot access the sulcus due to the interference caused by interconnecting elements.

This problem is solved by the apparatus and method of the present invention.

A dental hygiene device comprises first and second spaced fixed elements, a third element interconnected with both said first and second elements to define an opening between said first and second elements within which a dental structure to be flossed is receivable, an elongated cleaning element usable in a flossing operation with first and second longitudinal ends, a first member by which said cleaning element is held and selectively directable from said first element to said second element, and a second member associated with said second element by which said cleaning element is detachably secured. The dental hygiene device can be operated by one hand only. In addition, the user can clean the entire mouth using one dental hygiene device.

The dental hygiene device can be easily repositioned in order to floss another dental structure despite the presence of the interconnecting elements by detaching the cleaning element from the second member within the oral cavity.

The dental hygiene device replaces all existing cleaning devices for the interproximal spaces between teeth, and is also suitable for healthy dentition for which all teeth are separated.

In one embodiment, the first member is a displaceable cleaning element holder, e.g. linearly displaceable, which is sandwiched between two outer housing sections, and the second member is a retraction inhibiter driven by the holder for stabilizing the cleaning element, when displaced, in preparation for the flossing operation. The second element is preferably configured with an aperture for receiving the cleaning element when fully displaced, wherein the retraction inhibiter is configured with an indented end which is adapted to frictionally press on the cleaning element at a location spaced from the aperture by a distance equal to no more than five times a maximum thickness of the cleaning element, to prevent retraction of the cleaning element from the aperture as a result of forces applied to the cleaning element during the flossing operation.

In one aspect, the second element is also configured with a guide member for guiding the cleaning element to the second element aperture, said guide member having a guide member aperture through which the cleaning element is introducible and whose wall supports the cleaning element during application of forces to the cleaning element during the flossing operation.

In one aspect, the guide member is a conical guide member having an inner wall which tapers to a guide member center being aligned with the aperture and having an inner diameter only slightly greater than the maximum thickness of the cleaning element, so that the cleaning element, if misaligned when being displaced towards the second element, will follow curvature of said inner wall until being received in the aperture.

In one aspect, the cleaning element is bendable, the device further comprising an arcuate guide fixed to one of the housing sections at the first element, through an interior of said arcuate guide the bendable cleaning element is fed in order to be directed to the second element aperture.

In one embodiment, the dental hygiene device further comprises a frangible ampoule retained between the two housing sections and defining a fluid chamber for storing a liquid hygiene useful material, a cavity contiguous to said ampoule and through which a portion of the cleaning element extends, for receiving the hygiene useful material which is dischargeable from said ampoule, and a fixed puncture pin extending through said cavity, wherein one or more of the housing sections is formed with a weakened region, which when pressed, causes said ampoule to become pierced by said puncture pin and said portion of said cleaning element to be applied with said hygiene useful material.

In other embodiments, the dental hygiene device further comprises one or more of the following features:

a) the first and second elements are spaced first and second arms, respectively, for supporting the cleaning element during a flossing operation;

b) an engagement element provided with the first arm by which the cleaning element is detachably securable, and a pivot member fitted within, and positioned perpendicularly to, a pointing direction of the second arm for urging the cleaning element, when pivoting thereabout, to be maintained is a plane which is essentially coplanar with an outer surface of the second arm;

c) a first locking mechanism operatively connected to the first arm which is adapted to prevent decoupling of the cleaning element from the engagement element during a flossing operation;

d) a second locking mechanism operatively connected to the second arm which is adapted to irreleasably retain the cleaning element at an angularly fixed position throughout a picking operation;

e) an actuator connected to the first and second locking mechanisms; and

f) a release device for detaching the cleaning element from the pivot member.

The present invention is also directed to an adjustable interdental cleaning element, which is elongated and has first and second longitudinal ends, for suitably cooperating with a manipulating device in such a way so as to be usable in a flossing operation when said first end is held by a first element of said device and said second end is detachably secured to a second element of said device.

In one embodiment, the cleaning element is displaceable, such as linearly displaceable, until secured to the second element.

In one embodiment, said first end is pivotally connected to said first element, the cleaning element also being usable in a picking operation when said first end remains pivotally connected to said first element and said second end is detached from said second element.

The cleaning element may be coated, covered or impregnated with hygiene useful material.

The cleaning element may be a metallic filament that is magnetically and detachably securable to the second element.

The present invention is also directed to a method for readjusting an interdental cleaning element, comprising the steps of providing a dental hygiene device comprising first and second spaced fixed elements which are positionable such that a dental structure to be flossed is interposed between said first and second elements; selectively directing an elongated cleaning element usable in a flossing operation from said first element to said second element; and detachably securing said cleaning element to a member associated with said second element.

In one embodiment, the step of selectively directing the cleaning element is performed by displacing, e.g. linearly displacing, the cleaning element from the first element to the second element.

In one embodiment, the step of selectively directing the cleaning element is performed by bending the cleaning element between the first element and the second element.

In one embodiment, the step of selectively directing the cleaning element is performed by angularly displacing the cleaning element from the first element to the second element.

In one embodiment, the member associated with the second element is a retraction inhibiter configured to frictionally engage the cleaning element, and the step of detachably securing the cleaning element to the member associated with the second element is performed by applying a force to a finger engageable actuator mounted on a linearly displaceable holder that holds the cleaning element and that drives the retraction inhibiter until frictionally engaging the cleaning element, wherein the force continues to be applied during performance of the flossing operation.

These steps, which may be one hand performable, may be reversed, for example when the cleaning element is positioned intraorally.

### BRIEF DESCRIPTION OF THE DRAWINGS

In the drawings:

FIG. 1 is a front view of a prior art floss holder;

FIG. 2 is a front view of a dental hygiene device according to one embodiment of the present invention, shown in a flossing position;

FIG. 3 is a front view of the device of FIG. 2, shown in a picking position;

FIG. 4A is a perspective view from the side and front of a dental hygiene device according to another embodiment of the invention, shown in a flossing position;

FIG. 4B is a side view of the device of FIG. 4A;

FIG. 4C is a lengthwise cross sectional view of the device of FIG. 4A, cut along plane A-A of FIG. 4B;

FIG. 5 is a front view of the device of FIG. 2, schematically illustrated during angular displacement from a picking position to a flossing position while a cleaning element thereof is intraorally positioned;

FIG. 6 is a vertical cross sectional view of the gingiva, showing the relative location of the gingival sulcus;

FIG. 7 is a posterior view of three adjacent teeth while some of the oral structures have been removed for clarity, showing the difference between a healthy bone level and a reduced bone level with respect to two different teeth;

FIG. 8 is a perspective view from the front of a dental hygiene device according to another embodiment of the present invention, shown when the cleaning element is in a fully retracted position;

FIG. 9 is a perspective view from the front of the device of FIG. 8, shown when the cleaning element is in a fully advanced position;

FIG. 10 is a perspective view from the rear of a dental hygiene device according to another embodiment of the present invention, shown when the cleaning element is in a partially advanced position;

FIG. 11 is a side view of the device of FIG. 10;

FIG. 12 is a lengthwise cross sectional view of the device of FIG. 10, cut along plane B-B of FIG. 11;

FIG. 13 is a perspective view from the rear of the device of FIG. 10, shown when the rear housing section is removed and the cleaning element is in a partially advanced position;

FIG. 14 is a bottom view of the device of FIG. 10, shown when the cleaning element is in a partially advanced position;

FIG. 15 is an enlarged perspective view from the front and bottom of a portion of the device of FIG. 10, shown when one housing section, the cleaning element holder and the retraction inhibiter have been removed while the ampoule is represented by dots;

FIG. 16 is a is a lengthwise cross sectional view of the device of FIG. 10, shown when the cleaning element is in a fully advanced position;

FIG. 17 is a lengthwise cross sectional view of the device of FIG. 10, shown when the cleaning element is in a fully retracted position;

FIG. 18 is a lengthwise cross sectional view of a dental hygiene device according to another embodiment of the invention, shown when the cleaning element is in a fully retracted position;

FIG. 19 is a perspective view from the front of the device of FIG. 18, shown when the cleaning element is in a fully retracted position;

FIG. 20 is a rear view of the holder member used in conjunction with the device of FIG. 18, when removed from the housing sections;

FIG. 21 is a lengthwise cross sectional view of the device of FIG. 18, shown when the cleaning element is in a fully advanced position;

FIG. 22 is an enlarged front view of the device of FIG. 18, showing the frictional engagement applied by the retraction inhibiter to the cleaning element;

FIG. 23 is a cross sectional view of an undeformed flexible element and of a head element connected thereto which are used in conjunction with the device of FIG. 18, shown when in frictional engagement with a cleaning element;

FIG. 24 is a front view of the head element of FIG. 23, schematically illustrating a circumferentially extending notch formed therewith;

FIG. 25 is a lengthwise cross sectional view of a dental hygiene device according to another embodiment of the invention, shown when the cleaning element is in a fully retracted position;

FIG. 26 is a lengthwise cross sectional view of the device of FIG. 25, shown when the cleaning element is in a fully advanced position;

FIG. 27 is a schematic perspective view from the rear of a dental hygiene device according to another embodiment of the invention;

FIG. 28 is a schematic perspective view from the rear of the device of FIG. 27, shown when introduced into the oral cavity and positioned in flossable relation with a molar tooth; and

FIGS. 29-31 are a schematic perspective view from the rear of a dental hygiene device according to three other embodiments of the invention, respectively.

### DETAILED DESCRIPTION OF PREFERRED EMBODIMENTS

The present invention is a novel adjustable dental hygiene device for removing food debris from the gingival sulcus and interdental surfaces. This device is particular advantageous for users who have undergone dental treatment involving splints or ligatures that interconnect a few teeth together for one of the reasons described above, since dental floss supported by prior art devices is incapable of accessing the gingival sulcus and interdental surfaces from the occlusal direction of the teeth due to the presence of the interconnecting elements. In one embodiment, the device of the present invention can be used to both floss and pick out food particles when disposed at the same hand position.

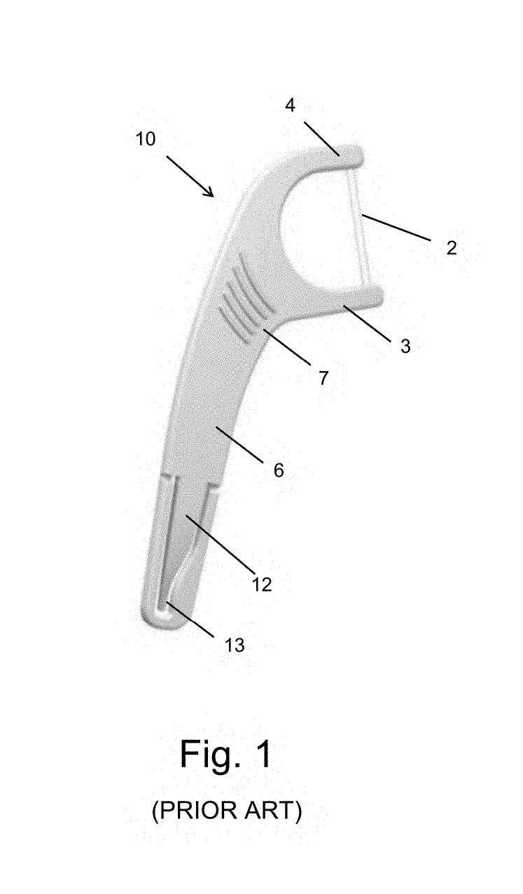

Reference is first made to FIG. 1, which illustrates a prior art floss holder 10 that is combined with a toothpick member 12. One or two strands 2 of floss having a thickness on the order of 2 mm or less and being generally waxed are irremovably pre-strung to each of two generally parallel arms 3 and 4 that protrude from a distal portion of body part 7 to define a C-shaped member. Handle 6 extends rearwardly from body part 7, at an angle from strands 2, and terminates with a toothpick member 12 that is die-cut within a central region of handle 6. Either toothpick member 12 or an adjacent portion of handle 6 is bendable in order to expose the toothpick member for a picking operation.

A picking operation with toothpick member 12 has two deficiencies. The first is that tip 13 of toothpick member 12 has a width that is significantly greater than the thickness of dental floss 2, and therefore cannot be introduced into the entire interproximal space between adjacent teeth or into the gingival sulcus in order to remove accumulated food particles. The second deficiency is that body part 7 has to be repositioned by an angle of about 180 degrees in order to suitably direct toothpick member 12 into an interproximal space. Due to the awkward and tedious repositioning operation, many users will be discouraged from picking out food particles with this prior art device.

It is therefore clear that using two hands to manipulate floss inside a relatively small space of the mouth is difficult and not practical, particularly for children and elderly people.

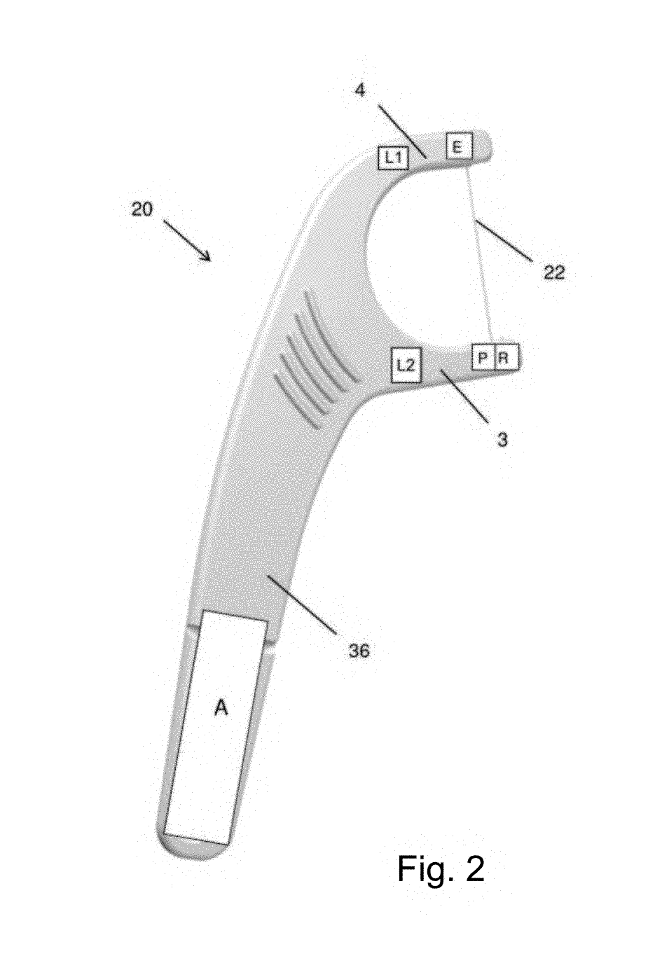

FIG. 2 schematically illustrates dental hygiene device 20 according to one embodiment of the present invention. Dental hygiene device 20 is shown to be configured similarly to prior art floss holder 10 with thin and narrow arms 3 and 4 that define a C-shaped border, but it may be configured in different ways as well. Cleaning element 22, which is shown to be set to a flossing position, is pivotally attached by pivot member P to arm 3 and is detachably securable to engagement element E provided with arm 4. To prevent decoupling of cleaning element 22 from engagement element E upon application of a force to arm 4 or to cleaning element 22 during a flossing operation, a first locking mechanism L1 is operatively connected to arm 4. A second locking mechanism L2 is operatively connected to arm 3 and/or to pivot member P, and is adapted to retain cleaning element 22 in a picking position. An actuator A mounted within handle 36, or within any suitable portion of device 20, is connected to locking mechanism L2, for example by means of an embedded cable, and serves to enable displacement of cleaning element 22 from a flossing position to a picking position, and vice versa, by decoupling locking mechanism L2. Alternatively or in addition, actuator A may be operable to set locking mechanism L2 to a locked state. Similarly, actuator A may be adapted to simultaneously set both locking mechanism L1 and locking mechanism L2 to a locked state by means of corresponding cables. If so desired, an individual actuator may be used for each of locking mechanisms L1 and L2.

Pivot member P is fitted within, and positioned perpendicularly to, the pointing direction of arm 3, and urges cleaning element 22, when pivoting thereabout, to be maintained is a plane which is essentially coplanar with the outer surface of arm 3. This pivoting action of cleaning element 22 ensures that it will be reliably secured to engagement element E prior to performance of a flossing operation, yet is assured of being properly positioned prior to the performance of a picking operation without having to reposition one's hand while grasping handle 36.

Cleaning element 22 is elongated so as to extend between arms 3 and 4, and is sufficiently thin to be used for flossing within interproximal or interdental spaces when secured to engagement element E. Cleaning element 22 may be rigid or flexible (and optionally with memory), and may be coated, covered or impregnated with hygiene useful material that is not harmful to teeth. Examples of hygiene useful material include fluoride, antibacterial agents, whitening agents, anti-inflammatory agents, anti-attachment agents, flavorants, wax and felt. Liquid hygiene useful material may be released into the oral cavity by a slow release process, depending on the physical properties of the cleaning element and on the pressure applied thereto during a flossing operation.

In one embodiment, dental hygiene device 20 comprises a release device R for detaching cleaning element 22 from pivot member P. The use of release device R allows cleaning element 22 to be replaced or modified, for example to use a second hygiene useful material instead of a first hygiene useful material, while reusing the same main device portion (which may made be for example, from stainless steel) for increased cost savings. According to this embodiment, the dental hygiene device 20 may further comprise a miniature container for slowly releasing hygiene useful material or a medicinal material on cleaning element 22.

Alternatively, the entire dental hygiene device may be disposable.

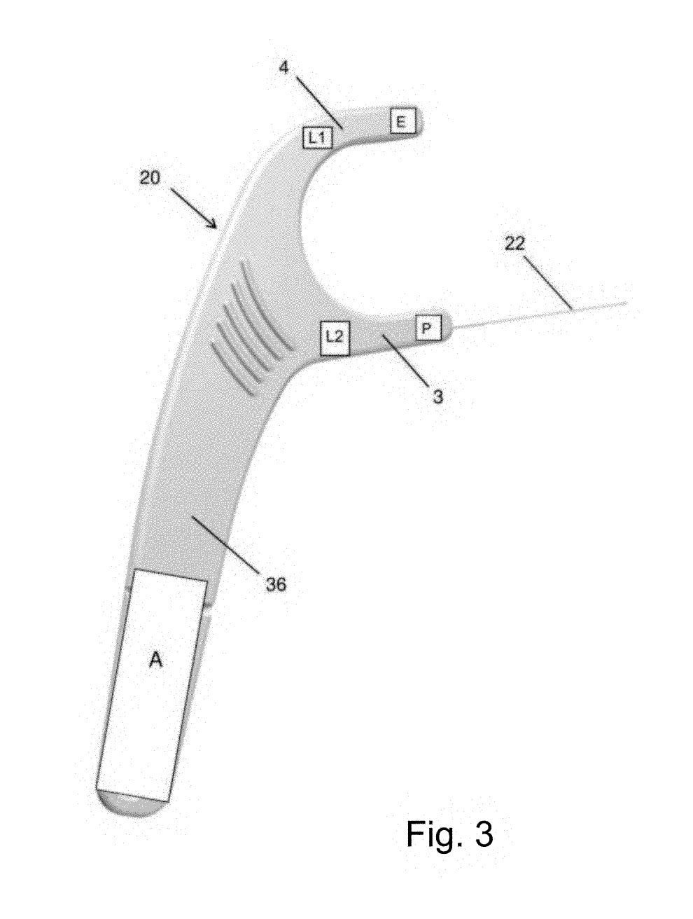

FIG. 3 illustrates dental hygiene device 20 when cleaning element 22 is set to a picking position. Cleaning element 22 is shown to have been pivoted approximately about 90 degrees about pivot member P, relative to the flossing position shown in FIG. 2; however, cleaning element 22 may be angularly fixed at any other suitable position as long as locking mechanism L2 is able to cooperate therewith at that angular position. At the given picking position, locking mechanism L2 is set to a locking state to irreleasably retain the angularly fixed position of cleaning element 22 throughout a picking operation even though it is separated from engagement element E. At this angularly fixed position, the user has sufficient control to selectively direct cleaning element 22 to a given interdental space and remove the accumulated food debris thereat.

Locking mechanism L2 for preventing additional angular displacement may be embodied by a spring loaded pin or interlocking key, a bolt-catch device, a cammed tongue-slot arrangement, or any other mechanism well known to those skilled in the art. Similar arrangements may also be implemented for locking mechanism L1.

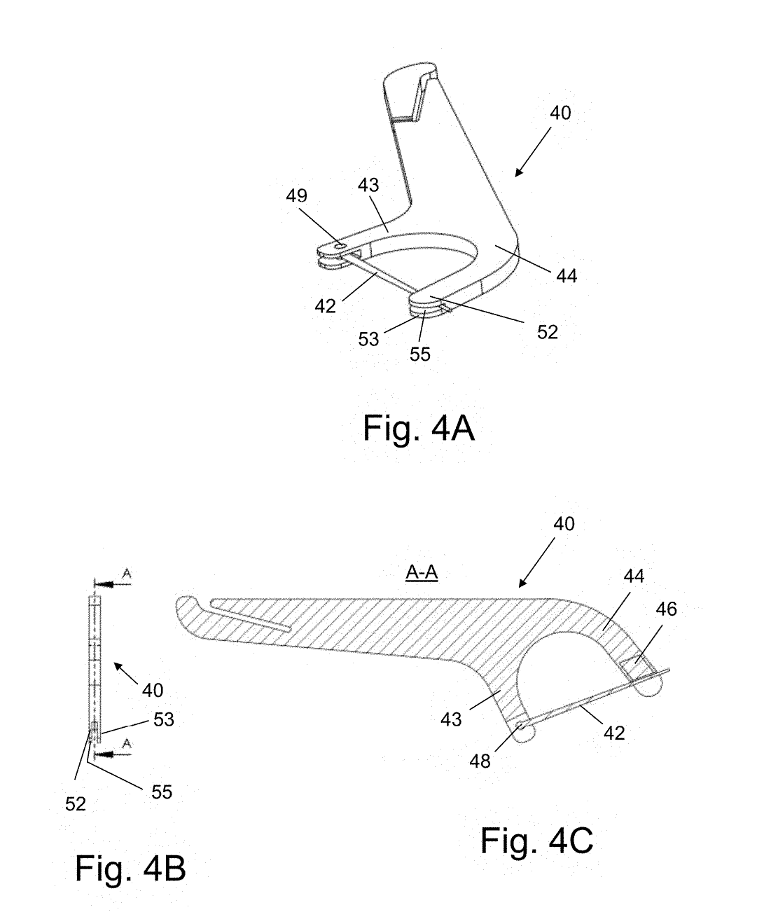

FIGS. 4A-C illustrate a dental hygiene device 40 embodied with a magnetic engagement element. In this embodiment, cleaning element 42 is a metallic filament which is magnetically attractable and securable to magnetic engagement element 46. Magnetic engagement element 46 is fixedly attached to arm 44 in such a way that filament 42, when detachably secured therewith, will be substantially perpendicular to arms 43 and 44 to facilitate a flossing operation. For example, magnetic engagement element 46 may be fitted within a central notch 55 formed within protective sheath elements 52 and 53. Although filament 42 is made of metallic material, it is not injurious to oral structures by being smoothened throughout its length or by being covered with a layer of hygiene useful material.

Filament 42 may be pivotally connected to arm 43 by means of pin 49 fitted in an circular aperture 48 formed in arm 43, for example passing through spaced sheaths or any other type of support elements. Through cooperation with pin 49, filament 42 is able to be pivoted in a plane which is essentially coplanar with the outer surface of arm 43.

Alternatively, filament 42 may be fixedly connected to a ring (not shown), which is received in circular aperture 48 formed in arm 43 in such a way so as to surround the terminal end of arm 43. The ring may be suitably sized to occupy a majority space of aperture 48 so that it will assured of engaging diametrically opposite wall surfaces of aperture 48. In this fashion, the ring functions as a pivot member that urges filament 42 to be pivoted in a plane which is essentially coplanar with the outer surface of arm 43.

The locking mechanism may be advanced within a slot formed internally within arm 43, so that, when actuated, will engage a portion of the pin or of the ring to prevent additional angular displacement. The engagement with the locking mechanism is sufficiently strong to support a picking operation even though filament 42 protrudes from arm 43 in cantilevered fashion.

In use, a flossing operation is carried out when the cleaning element is set to the flossing position and is locked in position. The cleaning element is then introduced into an interproximal space, by reciprocating the dental hygiene device being held by its handle, and afterwards vertically displacing the device while the cleaning element contacts a tooth surface and removes food particles or plaque that has accumulated. As referred to herein, a “tooth surface” is meant to include also a surface of an implant or of an element fixedly added to a tooth. Although not imperative, adjustment to the picking position may be simplified when the arm carrying the pivot member and the second locking mechanism is outwardly located, i.e. in a direction pointing outwardly from the oral cavity.

If a complete vertical stroke along the length of the contacted tooth surface cannot be completed due to the presence of an interproximally interconnecting element, adjustment from the flossing position to the picking position may be made in one-handed fashion without having to change the hand's grip position by first decoupling the first locking mechanism and then disengaging the cleaning element from the engagement element. While the disengaged cleaning element remains positioned in the interproximal space, the handle is rotated about the pivot member and away from the unattached end of the cleaning element until the cleaning element is disposed at a desired angle with respect to the arm carrying the pivot member, for example a coplanar disposition. The actuator is then activated to set the second locking mechanism, such as by pressing a suitable button on the handle, to maintain the cleaning element in the locked state throughout a picking operation. If interconnecting elements are deployed on the teeth, the cleaning element in the picking position is moved to an interproximal space that is apically spaced from the interconnecting elements in order to selectively remove food debris therefrom.

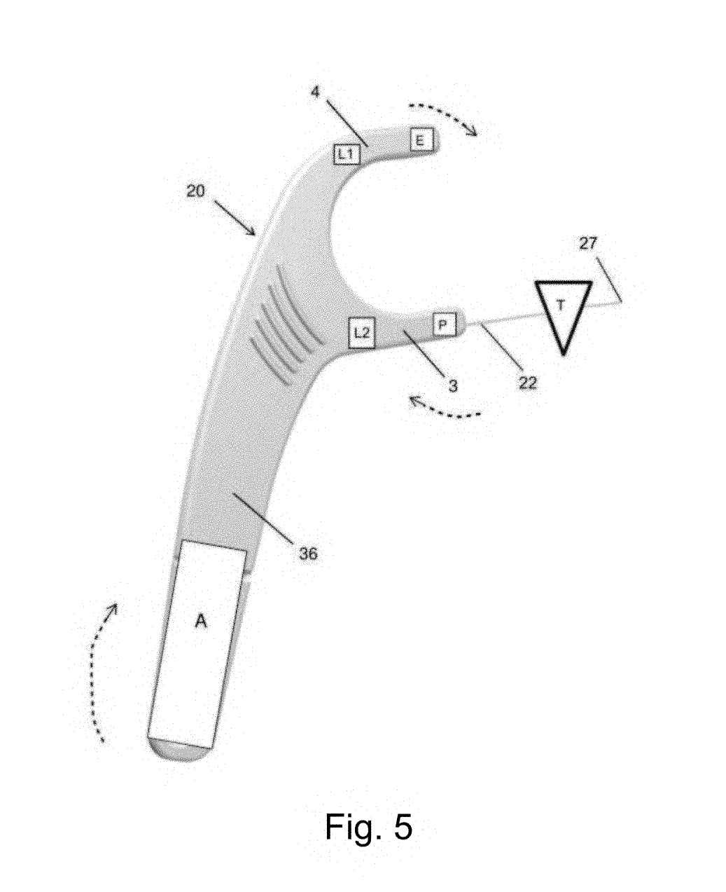

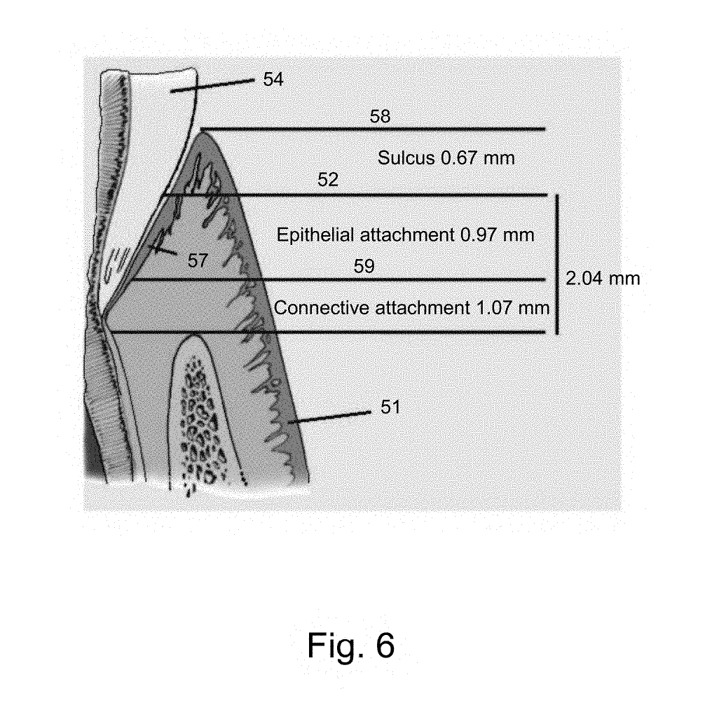

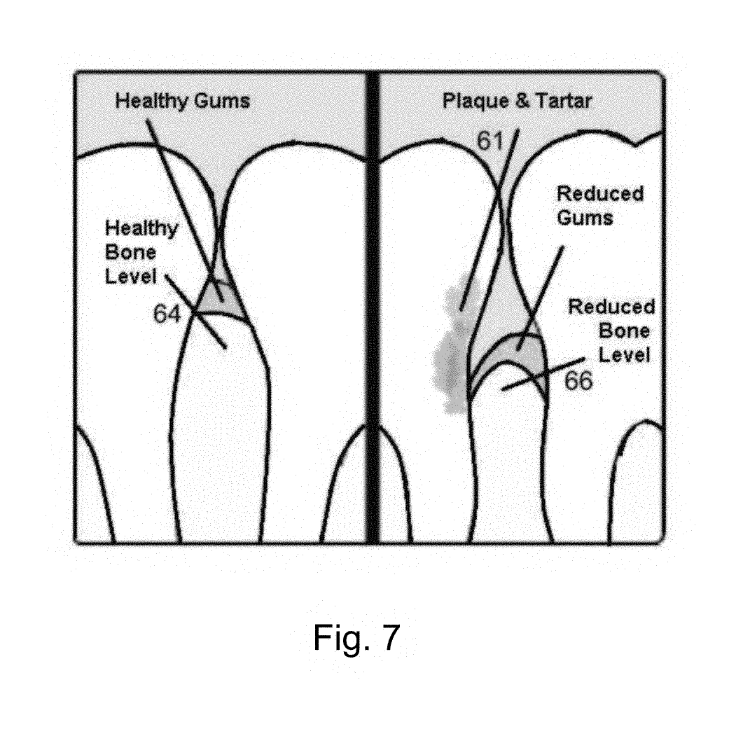

An improved cleaning action may be realized when the dental hygiene device is reset to the flossing position, after having been temporarily set to the picking position. With reference to FIG. 5, handle 36 is rotated about pivot member P, as indicated by the arrows, while cleaning element 22 remains positioned in an interproximal space and in juxtaposition with tooth T. Arm 4 is introduced into the oral cavity during rotation of handle 36, being displaced along an angular path until advancing lingually beyond tooth T and the other teeth adjacent thereto. To accommodate angular displacement of arm 4 into the oral cavity, cleaning element 22, as well as the spacing between arms 3 and 4, may be dimensioned with a limited length, so that the radius of rotation will be able to be smaller. After being completely angularly displaced, engagement element E is positioned in securing relation with a terminal end 27 of cleaning element 22, and then the first locking mechanism L1 is set. Thus the dental hygiene device can be used to perform a flossing operation by vertically displacing cleaning element 22 along interproximal tooth surfaces apically from an interconnecting element, to dramatically improve the ability to clean these surfaces by users having such interconnecting elements. In addition, the user is also able to clean the surfaces of the interconnecting elements and of teeth surfaces which are in the vicinity of the interconnecting elements when cleaning element 22 is set to the picking position.

These steps may be reversed in order to readjust the cleaning element from the picking position to the flossing position.

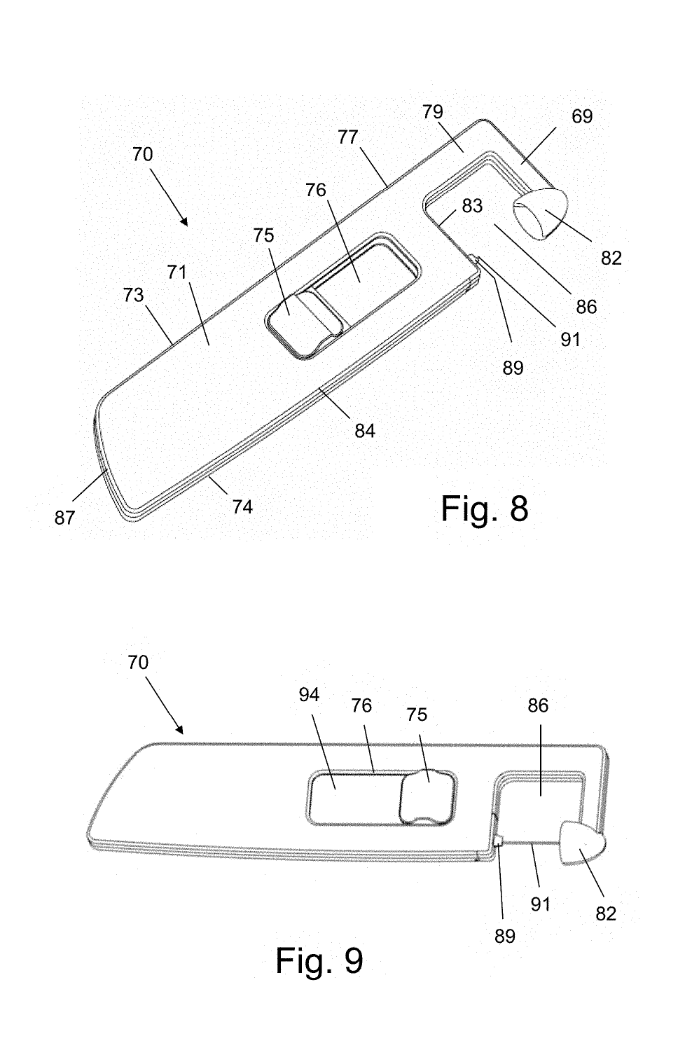

FIGS. 8-17 illustrate another embodiment of the invention wherein the dental hygiene device comprises a linearly displaceable cleaning element holder which is sandwiched between two outer thin housing sections, and a retraction inhibiter driven by the holder for stabilizing and inhibiting the retraction, or reverse movement, of the linearly displaced cleaning element in preparation for a flossing operation. The dental hygiene device is inexpensively manufactured, for example the housing sections may be made from injected plastic or from any other suitable thin and rigid material, and may be disposable.

With reference now to FIG. 8, each of identical housing sections 73 and 74 of dental hygiene device 70 is configured with a main substantially rectangular rearward region 71 formed with a central aperture 76, e.g. rectangular or oval, in which actuator 75 is fitted and from which the actuator outwardly protrudes, and with a forward region 69 terminating with a conical guide member 82. A straight interconnecting element 79 extends between forward region 69 and rearward region 71 to define together with forward region 69 an L-shaped configuration. As referred to herein, the term “forward” may be interchanged with the term “lingual” since forward region 69 is adapted to be positioned lingually with respect to a dental structure intended to be flossed.

Main region 71 and interconnecting element 79 have a common and continuous upper edge 77, while the bottom edge 84 of main region 71 terminates at bottom opened opening 86, e.g. square shaped or rounded, formed below upper edge 77 and separating main region 71 from forward region 69 which is provided with guide member 82. Aperture 76 is located closer to forward edge 83 of main region 71 than rear edge 87 thereof, which may be curved to ensure that a user's hand grasping device 70 during a flossing operation will not be injured.

When actuator 75 is in a retracted position as shown, a portion of the cleaning element holder is adapted to be received between the main region 71 of the two opposed housing sections and the retraction inhibiter is adapted to be received between the L-shaped configuration of the two opposed sections.

Although main region 71 is shown to be rectangular and forward region 69 is shown to be elongated, it will be appreciated that they may be configured in other ways as well, insofar as the two main regions 71 are able to house the cleaning element holder and the two forward regions 69 are able to house the retraction inhibiter. The two housing sections 73 and 74 may be attached to each other by any means well known to those skilled in the art, including mechanical fasteners, fusion, adhesion and sewing, for example releasable attachment means.

The directional terms describe dental hygiene device 70 when the latter is vertically disposed such that region 69 is positioned forwardly from main region 71 and edge 77 is located above actuator 75; however, it will be appreciated that device 70 is also operable when it is oriented in any other desired fashion.

Forward edge 83 is provided with a protuberance 89 aligned with the center of guide member 82. Protuberance 89 is bored with a central lumen within which cleaning element 91 is received when its holder is retracted, as controlled by the position of actuator 75. Protuberance 89 is used to locate a dental structure, by a tactile sensation, which is need of a flossing operation.

FIG. 9 illustrates dental hygiene device 70 after actuator 75 has been positioned forwardly to a fullest extent. Cleaning element 91 is shown to extend from protuberance 89 to guide member 82 while passing through opening 86. When actuator 75 is forwardly advanced as shown, cleaning element holder 94 connected to actuator 75 is also forwardly advanced to occlude aperture 76 and to drivingly engage the retraction inhibiter.

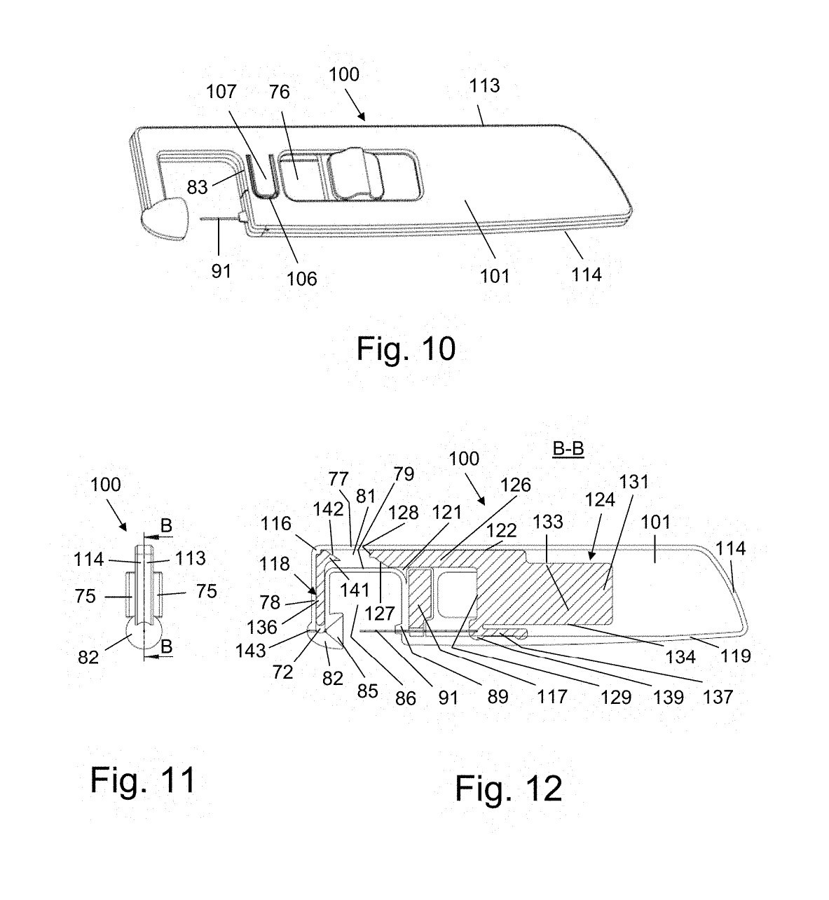

FIG. 10 illustrates another embodiment of the invention wherein the main region 101 of dental hygiene device 100, which is similar to device 70 of FIG. 8, is configured with a weakened region 106, for example a U-shaped cut. Weakened region 106 defines a tab 107, which when pressed, causes a frangible ampoule retained between housing sections 113 and 114 and defining a fluid chamber for storing a liquid hygiene useful material to become pierced, resulting in the discharge of the liquid hygiene useful material from the ampoule onto cleaning element 91, which is shown to be in a partially advanced position. Weakened region 106 is provided between forward edge 83 of main region 101 and central aperture 76, and may be formed in one or both of the housing sections.

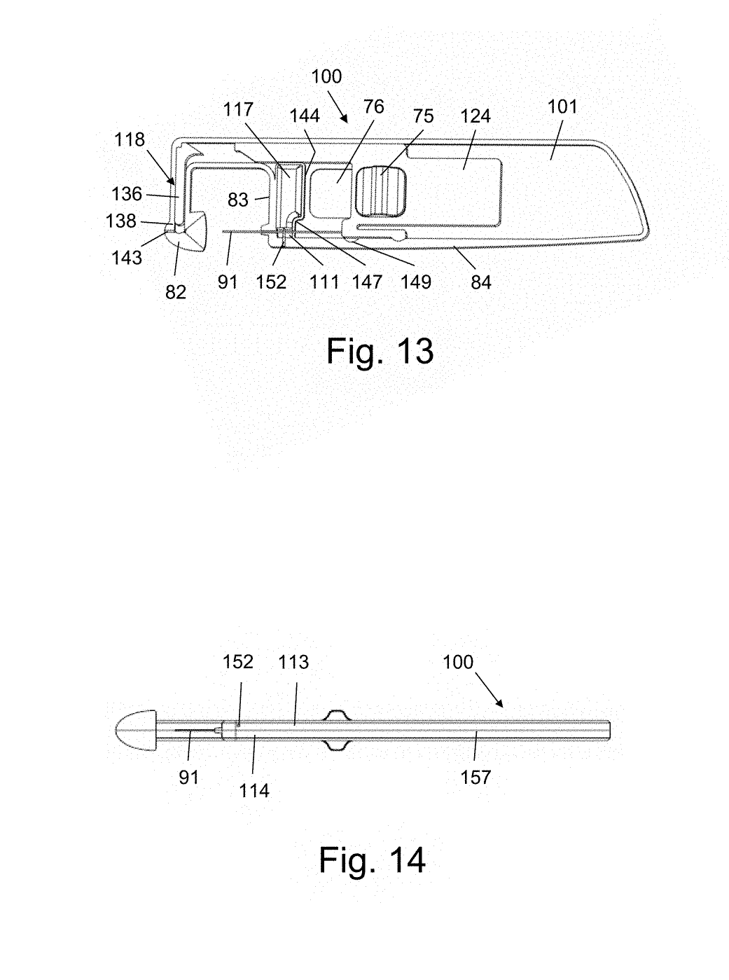

FIG. 11 is an end view from the front of dental hygiene device 100, showing housing sections 113 and 114 when fixedly attached to each other, a finger displaceable actuator 75 protruding from each housing section, and conical guide member 82 protruding downwardly from the housing sections. Actuator 75 may be integrally formed with cleaning element holder 124, such as by injection molding, as shown in FIG. 13, so as to protrude therefrom from both lateral sides, or alternatively may be connected to cleaning element holder 124.

As shown in FIG. 12, which is a lengthwise cross sectional view of dental hygiene device 100, cleaning element holder 124 is configured with an asymmetrical shape to accommodate the structure of interconnecting element 79 and main region 101 without interfering with ampoule 117. Elongated retraction inhibiter 118 is adapted to be displaceable, particularly gravitationally displaceable, along the leg 78 of forward region 69 which extends to conical guide member 82.

Housing section 114, and likewise housing section 113, has a lip 119 that extends along the entire periphery of the housing section, both the upper and lower edges thereof, until extending to conical guide member 82. Lip 119 inwardly protrudes from the external surface of the housing section and serves as a guiding surface along which retraction inhibiter 118 and cleaning element holder 124 are able to be displaced, while also defining their dimensions as they are fitted between two opposed lip surfaces. A lip portion 116, e.g. rectangular, may protrude into the interspace of groove 81 of interconnecting element 79 at the intersection of housing section upper edge 77 and leg 78, for temporarily seating retraction inhibiter 118 if dental hygiene device 100 were inverted. The lip of housing section 113 is adapted to be placed in abutting relation with the lip of 114 prior to attachment with each other.

Cleaning element holder 124 has an upper elongated portion 126 of a width substantially equal to the width between the lip portion adjoining upper edge 77 of the housing section and the lip portion adjoining opening 86, in order to direct its displacement within the recessed groove 81 of interconnecting element 79. The bottom edge 121 of upper portion 126 is shorter than upper edge 122 thereof. Oblique edge 127 extends upwardly from the forward end of bottom edge 121. A ram surface 128 substantially perpendicular to upper edge 122 of upper portion 126 extends upwardly from the forward end of oblique edge 127.

Cleaning element holder 124 also has a central portion 131 and a bottom portion 137. Central portion 131 is positioned rearwardly from upper portion 126, while adjoining a portion of the latter. Upper edge 133 and lower edge 134 of central portion 131 are spaced from the adjacent lip portion, in order to afford bottom portion 137 with sufficient resiliency. Bottom portion 137 is elongated and spaced downwardly from lower edge 134 of central portion 131, and is significantly shorter than central portion 131. A thickened interface 139 within which cleaning element 91 is embedded connects bottom portion 137 to the forward edge 129 of central portion 131. Interface 139 may be convex and may protrude forwardly from forward edge 129 of central portion 131.

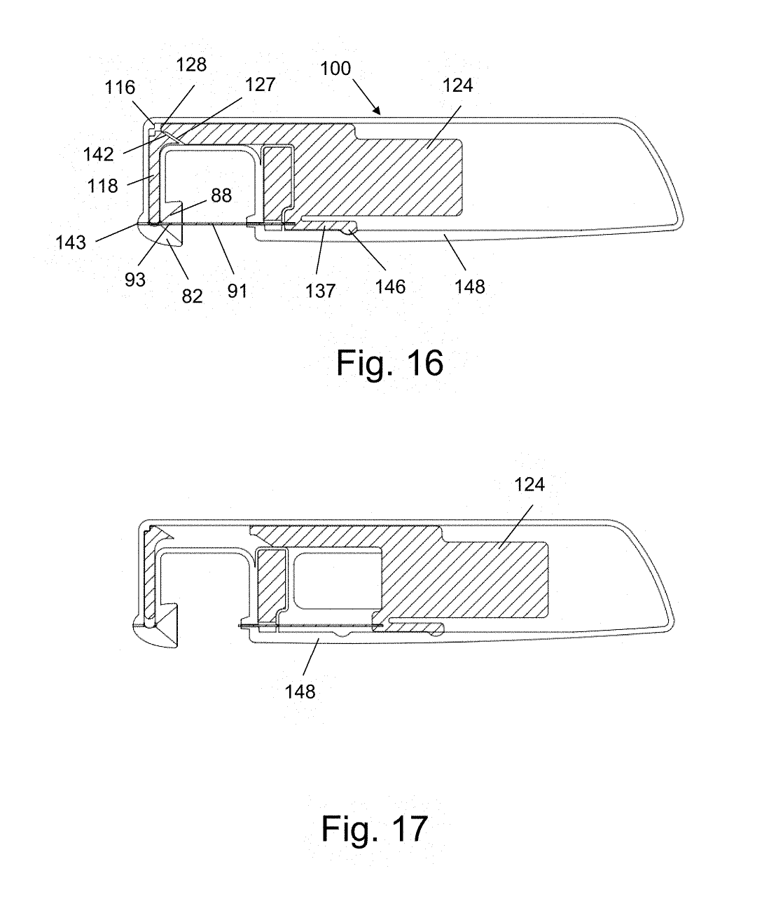

Cleaning element 91, in the illustrated partially advanced position, extends through cavity 111 (FIG. 13) provided below ampoule 117, protuberance 89 and partially into opening 86. When cleaning element 91 is fully advanced as shown in FIG. 16, it is introduced into the interior 85 of conical guide member 82 and into the narrow passageway 143 aligned at the center of guide member 82, whose diameter is only slightly greater than cleaning element 91.

Retraction inhibiter 118, which is shown to be positioned in near contact to housing section upper edge 77 but which is generally positioned downwardly therefrom due to the influence of gravity, has an elongated portion 136 of substantially the same width as, but shorter than, the recessed groove 72 of leg 78 along which elongated portion 136 is able to be displaced. A shortened transverse portion 141 extends transversely from elongated portion 136 into groove 81 of interconnecting element 79 for a sufficiently short length such that it can be contacted by upper portion 126 of cleaning element holder 124 only when cleaning element holder 124 is displaced forwardly to a fullest extent. Transverse portion 141, which terminates with an oblique edge 142 substantially parallel to oblique edge 127 of cleaning element holder 124, has a dimension which is less than the width of groove 81. The displacement of retraction inhibiter 118 along groove 72 is accordingly limited by the contact between the bottom edge of transverse portion 141, which may be parallel to upper edge 77, and the lip portion adjoining opening 86. The intersection of elongated portion 136 and transverse portion 141 may be configured with a removed portion that is complementary to protruding lip portion 116.

As shown in FIG. 13, elongated portion 136 of retraction inhibiter 118, which has a thickness approximately equal to a toothpick, terminates with a lower indented end 138. Indented end 138, which may be formed with a square notch, a V-shaped notch or a curved depression, is adapted to press downwardly on cleaning element 91 when fully advanced, so that the applied force, including a frictional force, will prevent discharge of cleaning element 91 from passageway 143 formed in conical guide member 82 as a result of the varying forces applied to the cleaning element, which may be rigid yet flexible, during a flossing operation.

Ampoule 117 positioned adjacent to tab 107 (FIG. 10) is received in a dedicated recess formed in both housing sections, between the lip portion at forward edge 83 of main region 101 and a varying border 144 positioned forwardly of central aperture 76 that extends downwardly to the lip portion at bottom edge 84 of main region 101 while defining a concave portion 147. Movement of ampoule 117 in one vertical direction is limited by the upper border of the dedicated recess and in the second vertical direction by concave portion 147 and by puncture pin 152 extending upwardly through cavity 111.

As shown in FIG. 14, puncture pin 152 is fixedly connected to the lip portion at bottom edge of housing section 113, and is laterally spaced from the midline 157 of dental hygiene device 100 at which housing sections 113 and 114 are attached to each other, so as not to interfere with cleaning element 91 as it extends through cavity 111 while being substantially aligned with midline 157.

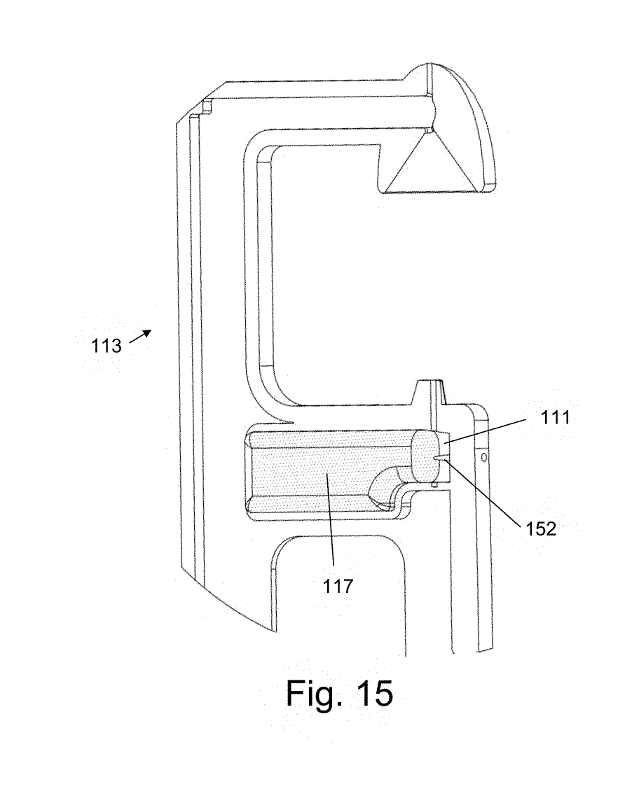

With reference to FIG. 15, the upper end of puncture pin 152 is rounded rather than sharply pointed, in order to reduce the likelihood that the completely sealed ampoule 117, which is represented by dots for clarity, will be punctured thereby. Ampoule 117 has a relatively thick and flexible outer sheet which, when the dental hygiene device is held in a substantially vertical disposition, will contact the upper end of puncture pin 152 and be depressed but not punctured by the pressure applied thereby, as illustrated.

When tab 107 (FIG. 10) is subsequently inwardly pressed, the outer sheet at or near to the bottom of ampoule 117 is flexed and forcefully directed to the upper end of puncture pin 152. This applied force causes the depth of depression of puncture pin 152 into the interior of ampoule 117 to be increased. The tension in the outer sheet is accordingly increased by the pressure applied by puncture pin 152 until it exceeds the tensile strength, or any other suitable mechanical property, whereupon the localized excessive tension causes the outer sheet to become punctured. The liquid hygiene useful material stored in the ampoule, which may include fluoride, antibacterial agents, whitening agents, anti-inflammatory agents, anti-attachment agents, flavorants, and a medicinal material, is then discharged through the puncture point into cavity 111. Since the liquid hygiene useful material is discharged in many directions, depending on the shape and size of the puncture, the portion of the cleaning element presently located within cavity 111 will be applied with the liquid hygiene useful material, to be of assistance during a flossing operation when the cleaning element is subsequently fully advanced by means of the actuator.

FIG. 16 illustrates dental hygiene device 100 after cleaning element 91 has been displaced to an advanced position. During manipulation of the actuator, cleaning element 91 may not follow a path that is completely aligned with passageway 143 if the actuator is jerked, for example. To compensate for misalignment of cleaning element 91, inner wall 88 of conical guide member 82 which tapers to a center which is aligned with passageway 143, urges the forwardly advancing cleaning element to follow the curvature of inner wall 88 after being in contact with the inner wall until coinciding with the longitudinal center 93 of guide member 82 as illustrated. Thus cleaning element 91, following additional advancement, will be subsequently received within passageway 143.

When cleaning element 91 is being received within passageway 143, it contacts a bottom edge of retraction inhibiter 118, causing the retraction inhibiter to be upwardly displaced. Following the slight upward displacement of retraction inhibiter 118, the bottom edge of ram 128 of cleaning element holder 124 contacts oblique edge 142 of retraction inhibiter 118. During subsequent advancement of cleaning element holder 124 in response to manipulation of the actuator, ram 128 forces retraction inhibiter 118 downwardly, and then oblique edge 127 of cleaning element holder 124 contacts oblique edge 142 of retraction inhibiter 118 to force retraction inhibiter 118 to its extreme downward position whereby indented end 138 of retraction inhibiter 118 (FIG. 13) frictionally engages and stabilizes cleaning element 91 during a flossing operation.

As an added feature, cleaning element holder 124 is able to be displaced to one or more discrete positions, to assist the user in manipulating the actuator. Resilient bottom portion 137 of cleaning element holder 124 may be configured with a terminal bulbous protrusion 146, which may be seated in a semispherical recess 149 (FIG. 13) formed in a bottom lip portion 148. A semispherical recess 149 may be defined at a location of bottom lip portion 148 that corresponds to a ram 128 position, when protrusion 146 is seated in the recess, by which it first contacts retraction inhibiter 118 as illustrated. Without looking at device 100, the user will feel when protrusion 146 has been seated, knowing that only an additional short displacement of the actuator will cause cleaning element 91 to be fully advanced and stabilized, after protrusion 146 has been easily unseated by virtue of the resiliency of bottom portion 137. Alternatively, the semispherical recess may be defined at a location of bottom lip portion 148 that corresponds to a fully advanced ram position, for example when contacting an edge of protruding lip portion 116. An additional semispherical recess may be defined at a location of bottom lip portion 148 that corresponds to a fully retracted position of cleaning element holder 124 shown in FIG. 17.

In use, a flossing operation may be easily carried out by flossing in an apical direction from interconnecting elements that extend mesiodistally or interproximally between teeth. The dental hygiene device is first positioned such that the dental structure to be flossed is interposed between the forward and rearward regions while the element interconnecting the forward and rearward regions is coronally disposed. While the actuator is retracted, the device is laterally displaced until the protuberance at the forward edge of the rearward region is in contact with dental structure intended to be flossed. The actuator is then fully advanced until the cleaning element is stabilized and frictionally engaged, whereupon a flossing operation is able to be performed. When the actuator is subsequently retracted, the device is laterally displaced to a different dental structure and the steps are repeated.

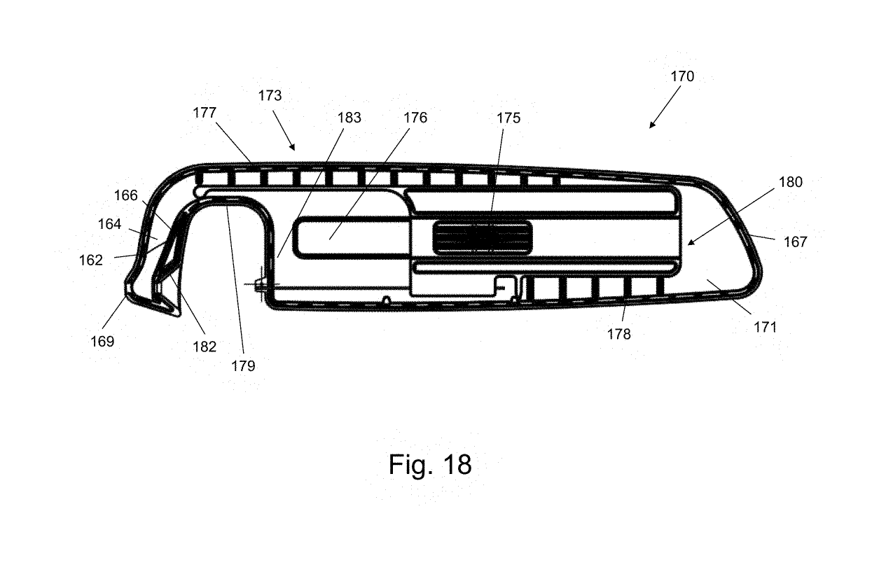

FIGS. 18-24 illustrate another embodiment of the invention wherein the dental hygiene device comprises an elongated and linearly displaceable cleaning element which is somewhat rigid and a deformable portion of the retraction inhibiter for inhibiting retraction of the linearly displaced cleaning element in preparation for a flossing operation. The dental hygiene device is inexpensively manufactured, for example the housing sections may be made from injected plastic or from any other suitable thin and rigid material, and may be disposable.

With reference to the cross sectional view of FIG. 18, dental hygiene device 170 comprises two identical housing sections 173 and a holder member 180 sandwiched between the two housing sections 173 for holding both the cleaning element and the retraction inhibiter. Each of the two identical housing sections 173 is configured with a main substantially rectangular rearward region 171 which may be rearwardly flared, a thin and elongated forward region 169 terminating with a conical guide member 182, and a central aperture 176, e.g. rectangular or oval, in which finger displaceable actuator 175 provided with holder member 180 is fitted and from which the actuator outwardly protrudes. A downwardly curved interconnecting element 179 extends between forward region 169 and rearward region 171 to define together with forward region 169 a U-shaped configuration which facilitates a cost effective manufacturing process. A thickened protruding peripheral lip 167 is provided along the entire periphery of a housing section 173, to facilitate the coupling together of the two housing sections.

A groove 164 is defined between forward edge 162 and rearward edge 166 of forward region 169, which are positioned at an angle, e.g. 190-200 degrees, with respect to forward edge 183 of rearward region 171. Rearward edge 166 extends downwardly until abutting guide member 182. The groove 164 formed within forward region 169 is in communication with another groove formed between the downward lip of interconnecting element 179 and the bottom coplanar edge of a plurality of mutually parallel, longitudinally spaced spacers 177, which extend downwardly from a portion of the upper lip of housing section 173 between interconnecting element 179 and an intermediate region of rearward region 171. A plurality of mutually parallel and longitudinally spaced spacers 178 defining an upper coplanar edge extend upwardly from a portion of the bottom lip of housing section 173 at an intermediate region of rearward region 171, such that most of lower spacers 178 are located rearwardly from upper spacers 177.

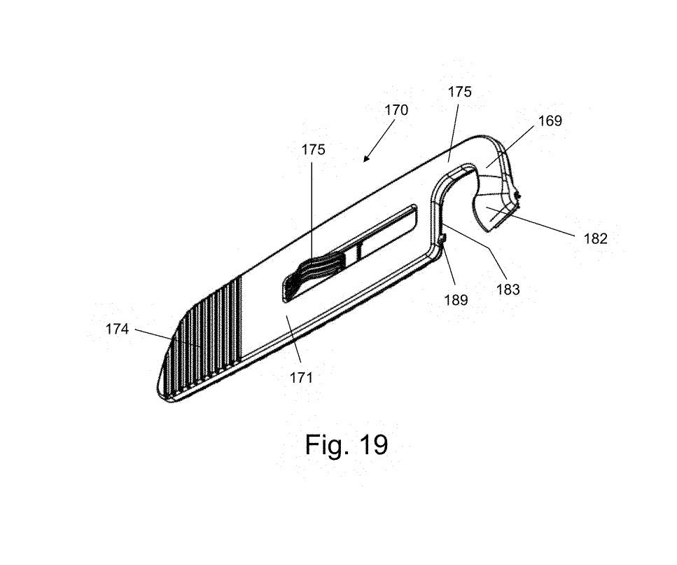

An assembled dental hygiene device 170 is illustrated in FIG. 19, showing bored protuberance 189 which is provided at forward edge 183 of rearward region 171 and which is aligned with the center of guide member 182. A rearward portion of rearward region 171 is provided with a grip 174 made of a friction enhancing material to assist a user during a flossing operation.

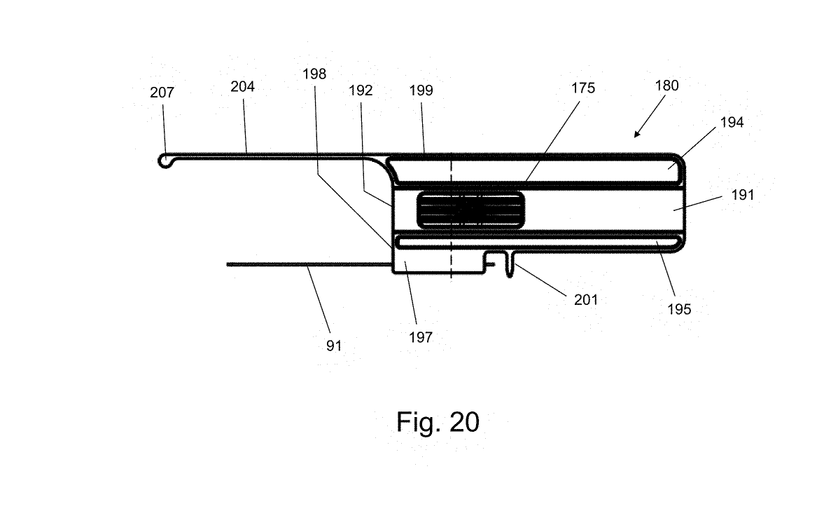

As shown in FIG. 20, holder member 180 is configured with a laterally central surface 191 from which laterally protrudes, at both lateral faces thereof, upper 194 and lower 195 smooth gliding surfaces between which actuator 175 is interposed, in order to movably contact a corresponding inner face of the housing section with minimal friction. A lower gliding surface 195 may have a smaller vertical dimension than upper gliding surface 194. Cleaning element 91 is integrated with, or otherwise held by, generally rectangular holding element 197, which is in abutment from below with lower gliding surface 195, such that the forward edge 198 of holding element 197 is aligned with the forward edge 192 of central surface 191. A stopper 201, e.g. narrow and vertically extending, may be slightly rearwardly spaced from holding element 197 and extend downwardly from lower gliding surface 195, in order to limit the rearward displacement of holder member 180 upon contacting the forwardmost spacer 178. The entire holder member 180 is displaced longitudinally in response to movement of actuator 175 in a similar direction.

In this embodiment, the retraction inhibiter comprises an elongated and flexible element 204 that may extend forwardly from the upper edge 199 of upper gliding surface 194, and a bulbous head element 207 positioned at the terminal end of flexible element 204, to assist in navigation and in frictionally engaging cleaning element 91. Flexible element 204, which has a small thickness on the order of a few millimeters, is made from a material that has sufficient mechanical strength to transmit the force being applied onto actuator 175 to head element 207 when contacting a cleaning element 91 during a flossing operation in order to inhibit retraction of the latter as will be described hereinafter, yet has sufficient fatigue resistance to be able to be cyclically bent and unbent by a bend angle greater than 90 degrees when introduced through, and removed from, the groove provided in the forward region. Exemplary materials which are suitable for use with the thin flexible element 204 include polypropylene and copper. Although not shown, head element 207 is configured with a notch, such as a V-shaped notch, within which the elongated cleaning element 91 is receivable.

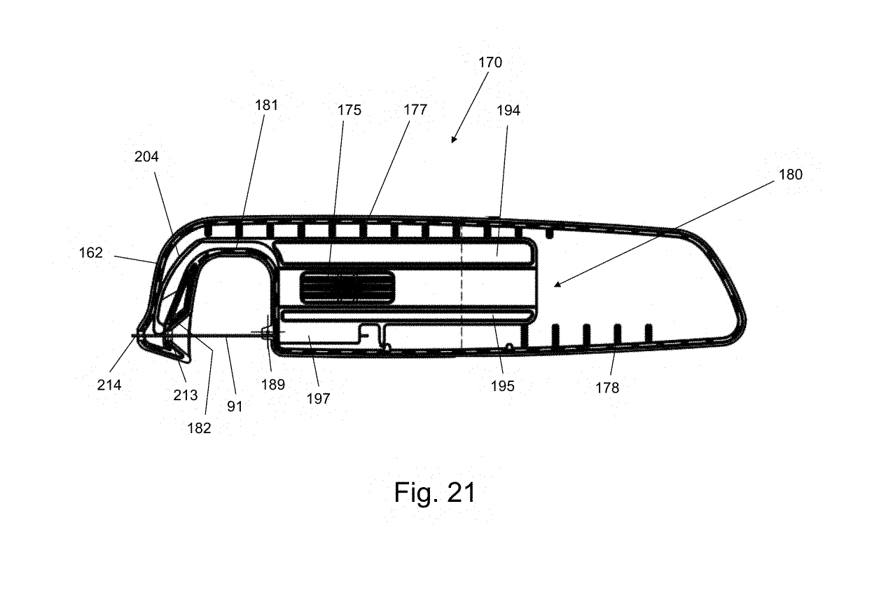

FIG. 21 illustrates dental hygiene device 170 when cleaning element 91 is set to a fully advanced position by a force applied by actuator 175. The forward displacement of holder member 180 is limited by forward edge 183 of rearward region 171 (FIG. 18).

In this fully advanced position, cleaning element 91, after extending through holding element 197 and the bored protuberance 189, passes through aligned apertures 213 and 214 formed at the center of conical guide member 182 and in the forward edge 162 of the forward region, respectively. Apertures 213 and 214 have a diameter slightly larger than that of cleaning element 91, and their walls are therefore not normally contacted by cleaning element 91. If a flossing operation were performed without use of the retraction inhibiter, the force applied by a dental structure within an interproximal or interdental space onto the flossable portion of cleaning element 91, i.e. between conical guide member 182 and bored protuberance 189, would cause the cleaning element held by holding element 197 to retract from aperture 214 and be slack, reducing the efficacy of the flossing operation.

The use of the retraction inhibiter thus facilitates proper operation of the dental hygiene device. Flexible element 204 is advanced forwardly simultaneously with the longitudinal displacement of holder member 180 and of cleaning element 91 in a similar direction. When holder member 180 is displaced forwardly, upper 194 and lower 195 gliding surfaces slidably contact the inner face of each housing section as well as the edge of spacers 177 and 178. At the same time, head element 207 is urged through the groove defined between the downward lip 181 of the interconnecting element and the bottom coplanar edge of spacers 177. When head element 207 subsequently contacts forward edge 162 of the forward region in response to the force continued to be applied to actuator 175, flexible element 204 is forced to deform to follow the path of head element 207 being displaced downwardly within the groove formed in the forward region. Dental hygiene device 170 is configured such that cleaning element 91 will be automatically fed through apertures 213 and 214 before being frictionally engaged by the retraction inhibiter.

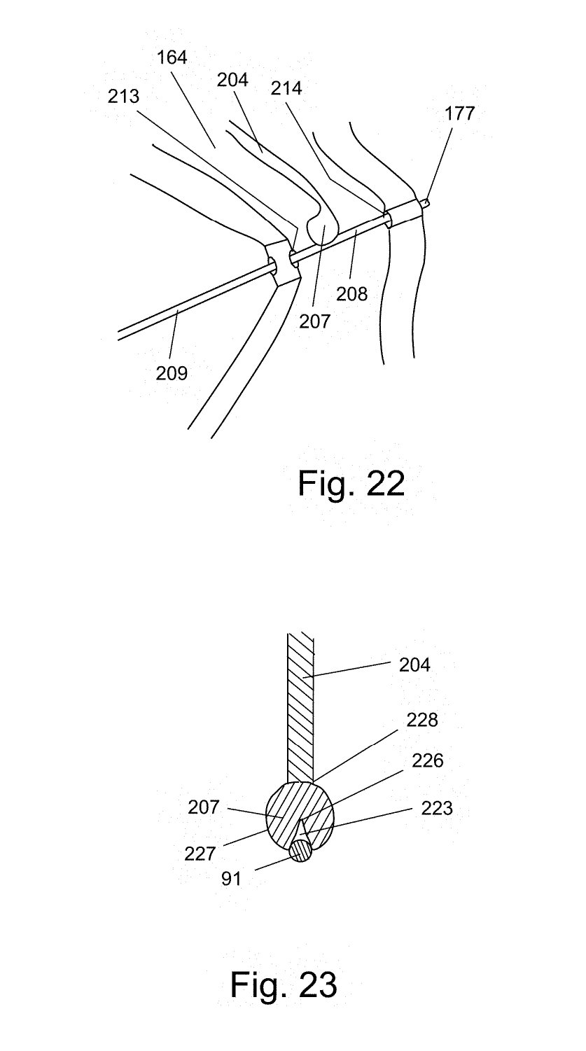

Following continued force applied to the actuator, head element 207 is displaced downwardly to a fullest extent within groove 164 of the forward region until frictionally engaging the retractable portion 208 of cleaning element 91, i.e. between apertures 213 and 214, through which cleaning element 91 is introduced without contact, as shown in FIG. 22. Less than half the height of head element 207 may be in frictional engagement with the retractable portion 208 of cleaning element 91. If a force continues to be applied to the actuator after retractable portion 208 is frictionally engaged, head element 207 will be forced to pivot about the pivot axis at the junction between flexible element 204 and head element 207 while flexible element 204 is brought closer to retractable portion 208, and then flexible element 204 will be forced to flex.

As shown in the cross sectional view of an undeformed flexible element 204 illustrated in FIG. 23, i.e. the flexible element 204 is completely linear and the head element 207 is non-pivoted with respect to the completely linear flexible element, an inner portion of head element 207 is formed with a V-shaped notch 223 while laterally outer regions of head element 207 are unnotched. V-shaped notch 223 is configured such that vertex 226 of the notch is centrally located within head element 207, and the maximum-width opening is formed in the periphery 227 of head element 207 and spaced, e.g. diametrically spaced, from the junction 228 between flexible element 204 and head element 207. The depth of notch 223 from vertex 226 to the maximum-width opening is approximately two to three times the diameter of cleaning element 91, or two to three times its maximum thickness, when a non-circular cleaning element 91 is employed. The width of the maximum-width opening may range from approximately a third to two times the maximum width of cleaning element 91.

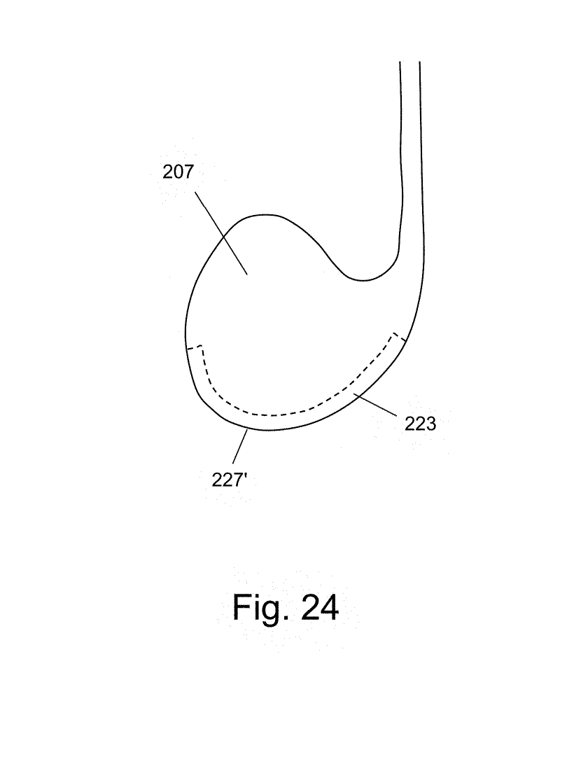

When viewing head element 207 in front view, as shown in FIG. 24, notch 223 schematically illustrated by dashed lines is not localized at a specific peripheral region, but rather circumferentially extends for a significant length of the distal periphery 227′ of head element 207, e.g. circumferentially extends 160 degrees. Accordingly, the retractable portion of the cleaning element is able to be frictionally engaged by notch 223 regardless of the spatial orientation of head element 207 when downwardly displaced within groove 164 by virtue of the circumferentially long notch 223 which has a depth greater than the maximum width of the cleaning element.

Similar frictional engagement may be achieved when the notch has a different cross section.

Referring back to FIGS. 21 and 22, the use of head element 207 for frictionally engaging the retractable portion 208 of the cleaning element facilitates an efficient flossing operation. Firstly, when a force continues to be applied onto actuator 175, cleaning element 91 is anchored by holding element 197 and the notch of head element 207, and therefore the cleaning element between the two anchoring points will be sufficiently tensioned to facilitate an efficient flossing operation without sagging. Secondly, the magnitude of the releasable frictional engagement applied by head element 207 onto retractable portion 208 of the cleaning element is surprisingly high to prevent retraction of cleaning element 91 from aperture 214 during a flossing operation and to thereby retain the tension of the cleaning element.

Without being bound by any theory, the retraction of cleaning element 91 from aperture 214 during a flossing operation is able to be inhibited despite the application of forces by a dental structure thereto during a flossing operation when the notch of head element 207 is spaced from aperture 214 or from aperture 213 by a distance equal to no more than five times a maximum thickness of cleaning element 91, e.g. no more than three or four times a maximum thickness of cleaning element 91. This short distance of retractable portion 208, for example between the notch of head element 207 and aperture 214, constitutes a sufficiently short moment arm on which the applied dental structure forces act during a flossing operation to resist generation of a moment that would normally cause slackening of the retractable portion and consequently retraction of the cleaning element from aperture 214.

By virtue of the releasable frictional engagement applied by head element 207, the retraction inhibitor provides a safety function by which it becomes disengaged from cleaning element 91 if the force applied to actuator 175 or the force applied by a dental structure to the cleaning element is excessive.

It will be appreciated that this arrangement of the retraction inhibitor is also applicable to other embodiments described herein.

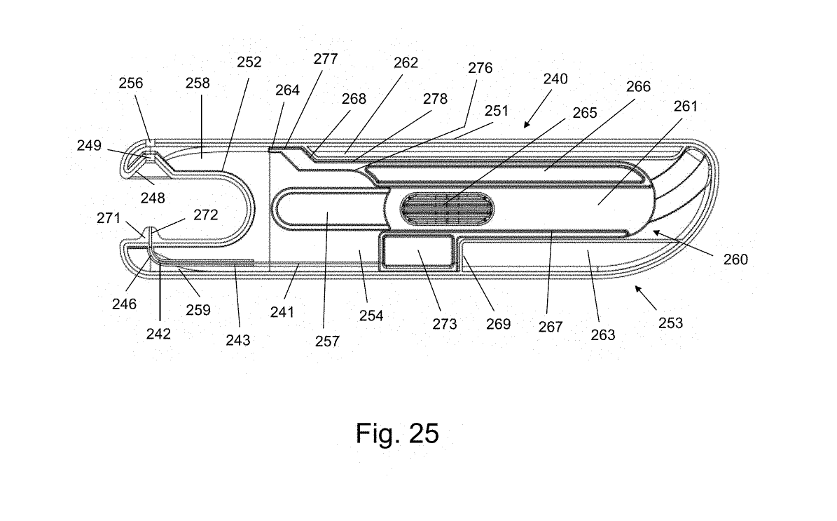

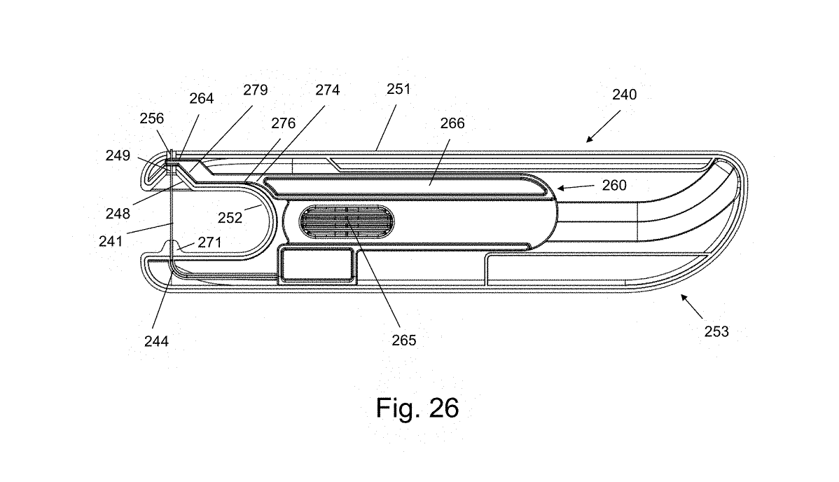

FIGS. 25 and 26 illustrate another embodiment of a dental hygiene device that is adapted to floss the generally inaccessible molar teeth. The first and second elements of the housing sections within which a dental structure to be flossed is receivable, rather than being substantially perpendicular to the direction of travel of the linearly displaceable holder with respect to previously described embodiments, are substantially parallel to the direction of travel of the linearly displaceable holder.

In order to accommodate this configuration, the dental hygiene device comprises a semi-rigid elongated and bendable cleaning element, two guides for the bendable cleaning element, and a retraction inhibiter for inhibiting retraction of the displaced cleaning element in preparation for a flossing operation. The dental hygiene device is inexpensively manufactured, for example the housing sections may be made from injected plastic or from any other suitable thin and rigid material, and may be disposable.

With reference to the cross sectional view of FIG. 25, dental hygiene device 240 comprises two identical housing sections 253 and a holder member 260 sandwiched between the two housing sections 253 for holding both the bendable cleaning element 241 and the retraction inhibiter 264. Each of the two identical housing sections 253 has a central aperture 257, e.g. elliptical, whose longitudinal axis defines the direction of travel of holder member 260. Housing section 253, which is substantially an elliptical structure, is configured with a main rearward region 254 and two arms 258 and 259 that protrude forwardly from rearward region 254 and are generally parallel to the longitudinal axis of aperture 257. A thickened protruding peripheral lip 251 is provided along the entire periphery of a housing section 253, to facilitate the coupling together of the two housing sections, including along the inner peripheral region 252 delimiting a U-shaped opening 245 between the two arms 258 and 259 which is suitable for receiving a dental structure to be flossed. The upper lip portion extends continuously across both rearward region 254 and upper arm 258, the lower lip portion extends continuously across both rearward region 254 and lower arm 259.

Housing section 253 has elongated upper 262 and lower 263 spacers vertically extending from the upper and lower lip portions, respectively, to define surfaces along which upper 266 and lower 267 smooth gliding surfaces slide when holder member 260, which laterally protrudes at both lateral faces of laterally central surface 261 thereof, is driven by a force applied to actuator 265 in a similar direction. Upper spacer 262 is longer than lower spacer 263, and its forward edge 268, which may be obliquely oriented, is located forwardly to the forward edge 269 of lower spacer 263.

Retraction inhibiter 264, which is configured with a notch or with an indented portion as described hereinabove in order to frictionally engage cleaning element 241, protrudes forwardly from upper gliding surface 266 by means of interface element 276 which may be coplanar with central surface 261. Interface element 276 is configured complementarily to the portion of upper spacer 262 which protrudes from upper gliding surface 266 when holder member 260 is in the illustrated fully retracted position, for example is angled. Interface element 276 may be made of low friction material to provide low friction contact when holder member 260 is linearly displaced. An upper edge 277 of interface element 276 continuous with retraction inhibiter 264 is adapted to movably contact the upper lip portion, and intermediate edge 278 vertically spaced from and substantially parallel to upper edge 277 is adapted to movably contact upper spacer 262. Retraction inhibiter 264 protrudes forwardly from forward edge 279 of interface element 276, which is substantially parallel to forward edge 268 of upper spacer 262.

The forwardly extending cleaning element 241 is integrated with, or otherwise held by, generally rectangular holding element 273, which is in abutment from below with lower gliding surface 267. In the illustrated fully retracted position of cleaning element 241, holding element 273 is in contact with the forward edge 269 of lower spacer 263 and thereby limits the rearward displacement of holder member 260. Also, the forwarded portion of interface element 276 may contact forward edge 268 of upper spacer 262 in order to limit the rearward displacement of holder member 260.

Conical guide member 248 is fitted in upper arm 258, so as to be continuous with both the upper lip and the inner peripheral region 252. A planar arcuate guide 243 laterally protrudes inwardly from, and is attached to, the inner face of housing section 253 at the lower arm 259, and is further attached from below to peripheral region 252. Arcuate guide 243, which has an inner cavity 246 through which cleaning element 241 is fed, is configured with a rearward straight portion substantially parallel to the longitudinal axis of aperture 257 and with a forward curved portion which is continuous with the rearward straight portion. Inner cavity 246 of arcuate guide 243 is continuous with the central bore 272 bored within protuberance 271, which protrudes upwardly from inner peripheral region 252 and which is aligned with apertures 249 and 256 formed at the center of conical guide member 248 and in the upper lip 251, respectively. Apertures 248 and 256 have a diameter slightly larger than that of cleaning element 241, and their walls are therefore not normally contacted by cleaning element 241. In the illustrated fully retracted position of cleaning element 241, the terminal end 242 of the cleaning element is located approximately at the forward end of the straight portion of arcuate guide 243.

FIG. 26 illustrates device 240 when holder member 260 has been displaced to a fully advanced position. At this fully advanced position, forward edge 279 of interface element 276 contacts the rearward surface of conical guide member 248 and curved bottom edge 274 of interface element 276 contacts inner peripheral region 252 of housing section 253, to limit the forward displacement of holder member 260.

While holder member 260 is being forwardly displaced, cleaning element 241 is fed through the curved portion 244 of the arcuate guide and is therefore urged to bend, and then to pass through bore 272 bored within protuberance 271 and through aligned apertures 249 and 256 formed at the center of conical guide member 248 and in the upper lip 251, respectively. Since cleaning element 241 has been previously introduced into the cavity of the arcuate guide, the cleaning element will be fed through apertures 249 and 256 before forward edge 279 of interface element 276 contacts the rearward surface of conical guide member 248, thus enabling retraction inhibiter 264 to frictionally engage the retractable portion of cleaning element 241.

In use, device 240 is introduced into the oral cavity while being inclined, such that the two arms 258 and 259 are located at a different height than rearward region 254, in order to access a selected molar tooth with minimal stretching of the nearby cheek. While the dental structure to be flossed is located between the two arms 258 and 259 and actuator 265 is retracted, the device is displaced until protuberance 271 is in contact with the dental structure intended to be flossed. After a force is applied to actuator 265 that causes holding member 260 to be advanced, cleaning element 241 to be introduced into an interproximal space, and less than half the length of retraction inhibiter 264 to frictionally engage the retractable portion of cleaning element 241, a flossing operation is performed while a force continues to be applied to the actuator by displacing the device in an apical direction so that the cleaning element will contact a tooth surface and remove food particles or plaque that has accumulated.

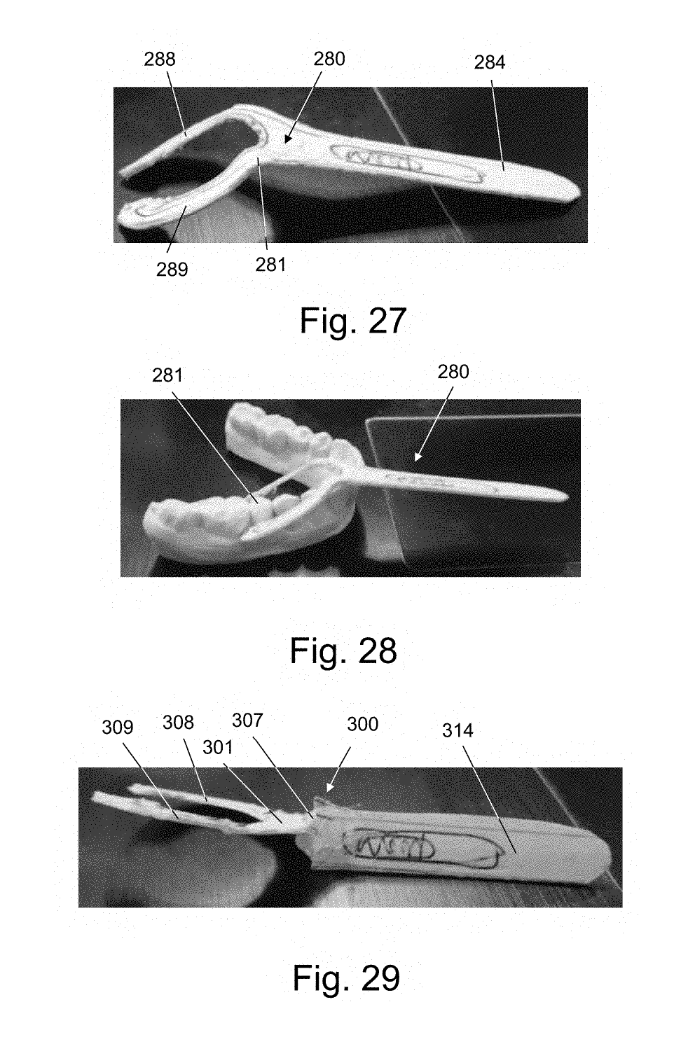

FIG. 27 schematically illustrates a device 280 similar to device 240 of FIG. 25, but which is configured with coplanar arms 288 and 289 that are angularly spaced, by an angle of up to approximately 30 degrees, from rearward region 284, for example at a portion 281 of the U-shaped, inner peripheral region defining a single axis of rotation, to assist in accessing a molar tooth 281 as shown in FIG. 28. A non-planar arcuate guide that is fixed to one of the housing sections at both rearward region 284 and lower arm 289 serves to guide the cleaning element to the center of the conical guide member located at upper arm 288 and to be frictionally engaged by the retraction inhibiter. An additional fixed, non-planar arcuate guide may be employed to guide the retraction inhibiter along upper arm 288 to the retractable portion of the cleaning element by means of a flexible element connected to the retraction inhibiter and to the holding member.

FIG. 29 schematically illustrates a device 300 similar to device 240 of FIG. 25, but which is configured with coplanar arms 308 and 309 and intermediate interface region 301 that are spatially spaced, by an angle of approximately 90 degrees, from the plane of rearward region 314, to assist in accessing a molar tooth. Each of the housing sections is configured with a twisted portion 307 between intermediate interface region 301 and a forward area of rearward region 314 to facilitate the spatial spacing. A non-planar arcuate guide that is fixed to one of the housing sections at both rearward region 314 and lower arm 309 serves to guide the cleaning element to the center of the conical guide member located at upper arm 308 and to be frictionally engaged by the retraction inhibiter. An additional fixed, non-planar arcuate guide may be employed to guide the retraction inhibiter along upper arm 308 to the retractable portion of the cleaning element by means of a flexible element connected to the retraction inhibiter and to the holding member.

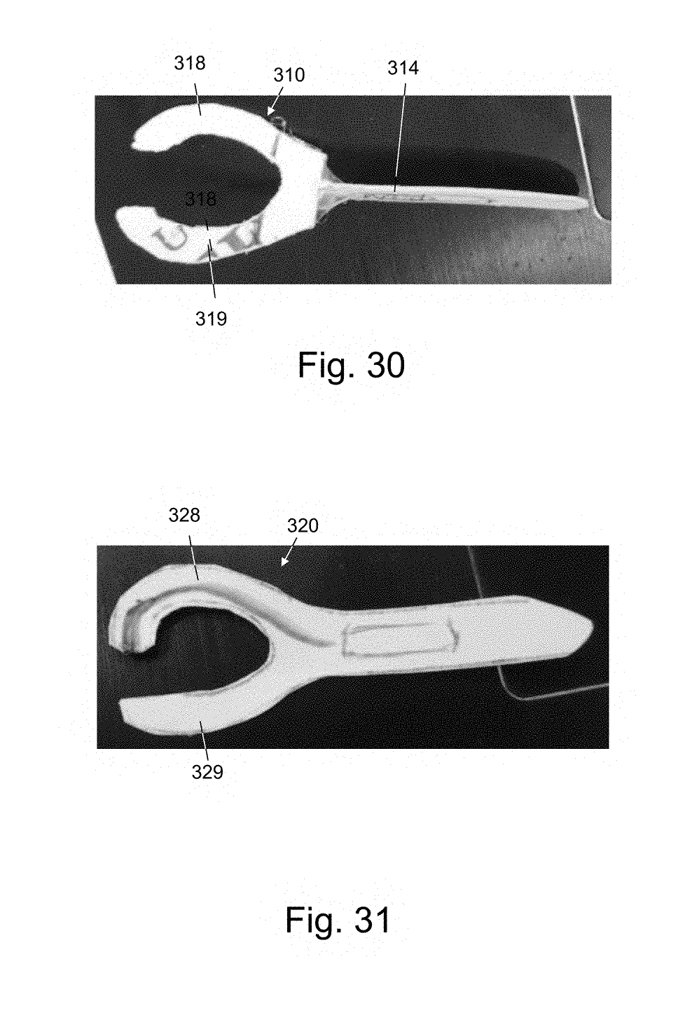

FIG. 30 schematically illustrates a device 310 similar to device 240 of FIG. 25, but which is configured with symmetrical arcuate arms 318 and 319. A planar arcuate guide configured without a straight portion that is fixed to one of the housing sections at both rearward region 314 and lower arm 319 serves to guide the cleaning element to the center of the conical guide member located at upper arm 319 and to be frictionally engaged by the retraction inhibiter. An additional fixed, planar arcuate guide may be employed to guide the retraction inhibiter along upper arm 318 to the retractable portion of the cleaning element by means of a flexible element connected to the retraction inhibiter and to the holding member.

FIG. 31 schematically illustrates a device 320 similar to device 310 of FIG. 30, but which is configured with non-symmetrical arcuate arms 328 and 329, each of which having a different angle of curvature.

The device of the present invention is user friendly, easy to use, and can be manipulated with one hand only. It allows penetrating the interproximal areas from buccal to lingual-palatal with ease and accuracy. This way, patients will be able to maintain a high level of hygiene and substantially improve the prognosis of all the different kinds of dental treatments, which are costly and time consuming.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A dental hygiene device, comprising:
a) first and second spaced fixed elements;
b) a third element interconnected with both said first and second elements to define an opening between said first and second elements within which a dental structure to be flossed is receivable;
c) an elongated cleaning element usable in a flossing operation with first and second longitudinal ends;
d) a first member by which said cleaning element is held and selectively directable from said first element to said second element; and
e) a second member associated with said second element by which said cleaning element is detachably secured.

2. The dental hygiene device according to claim 1, wherein the first member is a displaceable cleaning element holder which is sandwiched between two outer housing sections, and the second member is a retraction inhibiter driven by the holder for stabilizing the cleaning element, when displaced, in preparation for the flossing operation.

3. The dental hygiene device according to claim 2, wherein the second element is configured with an aperture for receiving the cleaning element when fully displaced, and wherein the retraction inhibiter is configured with an indented end which is adapted to frictionally press on the cleaning element at a location spaced from the aperture by a distance equal to no more than five times a maximum thickness of the cleaning element, to prevent retraction of the cleaning element from the aperture as a result of forces applied to the cleaning element during the flossing operation.

4. The dental hygiene device according to claim 3, wherein the second element is also configured with a guide member for guiding the cleaning element to the second element aperture, said guide member having a guide member aperture through which the cleaning element is introducible and whose wall supports the cleaning element during application of forces to the cleaning element during the flossing operation.

5. The dental hygiene device according to claim 4, wherein the guide member is a conical guide member having an inner wall which tapers to a guide member center being aligned with the aperture and having an inner diameter only slightly greater than the maximum thickness of the cleaning element, so that the cleaning element, if misaligned when being displaced towards the second element, will follow curvature of said inner wall until being received in the aperture.

6. The dental hygiene device according to claim 3, wherein the cleaning element is bendable, the device further comprising an arcuate guide fixed to one of the housing sections at the first element, through an interior of said arcuate guide the bendable cleaning element is fed in order to be directed to the second element aperture.

7. The dental hygiene device according to claim 2, further comprising a frangible ampoule retained between the two housing sections and defining a fluid chamber for storing a liquid hygiene useful material, a cavity contiguous to said ampoule and through which a portion of the cleaning element extends, for receiving the hygiene useful material which is dischargeable from said ampoule, and a fixed puncture pin extending through said cavity, wherein one or more of the housing sections is formed with a weakened region, which when pressed, causes said ampoule to become pierced by said puncture pin and said portion of said cleaning element to be applied with said hygiene useful material.

8. The dental hygiene device according to claim 2, wherein the retraction inhibiter is connected to the holder.

9. The dental hygiene device according to claim 1, wherein the first and second elements are spaced first and second arms, respectively, for supporting the cleaning element during the flossing operation.

10. An adjustable interdental cleaning element, which is elongated and has first and second longitudinal ends, for suitably cooperating with a manipulating device in such a way so as to be usable in a flossing operation when said first end is held by a first element of said device and said second end is detachably secured to a second element of said device.

11. The cleaning element according to claim 10, which is displaceable until secured to the second element.

12. The cleaning element according to claim 10, which is coated, covered or impregnated with hygiene useful material.

13. The cleaning element according to claim 12, which has a first covering of first hygiene useful material, said first covering being replaceable with a second covering of second hygiene useful material.

14. The cleaning element according to claim 10, which is a metallic filament that is magnetically and detachably securable to the second element.

15. A method for readjusting an interdental cleaning element, comprising the steps of:
a) providing a dental hygiene device comprising first and second spaced fixed elements which are positionable such that a dental structure to be flossed is interposed between said first and second elements;
b) selectively directing an elongated cleaning element usable in a flossing operation from said first element to said second element; and
c) detachably securing said cleaning element to a member associated with said second element.

16. The method according to claim 15, wherein the step of selectively directing the cleaning element is performed by displacing the cleaning element from the first element to the second element.

17. The method according to claim 15, wherein the step of selectively directing the cleaning element is performed by bending the cleaning element between the first element and the second element.

18. The method according to claim 15, which is performed when the cleaning element is positioned intraorally.

19. The method according to claim 15, which is one hand performable.

20. The method according to claim 15, wherein the member associated with the second element is a retraction inhibiter configured to frictionally engage the cleaning element, and the step of detachably securing the cleaning element to the member associated with the second element is performed by applying a force to a finger engageable actuator mounted on a linearly displaceable holder that holds the cleaning element and that drives the retraction inhibiter until frictionally engaging the cleaning element, wherein the force continues to be applied during performance of the flossing operation.
